(19) United States
(12) Patent Application Publication
(10) Pub. No.: US 2016/0337089 A1
(43) Pub. Date: Nov. 17, 2016

(54) Method, System, Terminal and Base Station for Transmitting Hybrid Automatic Repeat Request Acknowledgement (HARQ-ACK) Feedback Information

(71) Applicant: ZTE CORPORATION, Shenzhen City, Guangdong Province (CN)

(72) Inventors: Xianming CHEN, Shenzhen (CN); Bo DAI, Shenzhen (CN); Zhaohua LU, Shenzhen (CN)

(73) Assignee: ZTE CORPORATION, Shenzhen City, Guangdong Province (CN)

(21) Appl. No.: 15/109,661

(22) PCT Filed: Aug. 4, 2014
(86) PCT No.: PCT/CN2014/000749

§ 371 Date: Jul. 5, 2016

(30) Foreign Application Priority Data
Jan. 7, 2014 (CN) 201410006500.6

(51) Int. Cl. H04L 1/18; H04L 5/00

(52) U.S. Cl. CPC H04L 1/1854; H04L 1/1812; H04L 5/0058

(57) ABSTRACT

The embodiments of the present document disclose a transmission method and system for HARQ-ACK feedback information, a terminal and a base station, herein the transmission method includes: determining, by a base station, a PUCCH corresponding to a terminal according to a preset transmission policy, herein the transmission policy is: transmitting, by the base station, PUCCH indication signaling to the terminal, the indication signaling carrying information of one PUCCH of preset N PUCCHs, the one PUCCH being a PUCCH corresponding to the terminal; or determining a PUCCH corresponding to the terminal according to preset resources; or determining a preset terminal-specific PUCCH to be a PUCCH corresponding to the terminal; and receiving by the base station, HARQ-ACK feedback information through the determined PUCCH.

### TECHNICAL FIELD

The present document relates to a wireless communication technology, in particular to a transmission method for HARQ-ACK feedback information, a terminal and a base station.

### BACKGROUND OF THE RELATED ART

MTC (Machine Type Communication) is also called as M2M (Machine To Machine), and UE (User Equipment) or terminals thereof are main application forms of Internet of Things at the present stage. Low power consumption and low cost are important guarantees for massive application thereof. At present, the M2M technology has already been supported by international famous manufacturers such as NEC, HP, CA, Intel, IBM and AT&T and has already been recognized by mobile operators in all countries. At present, most M2M devices deployed in the mart are mainly based on a GSM (Global System of Mobile communication).

In recent years, since spectral efficiency of LTE (Long Term Evolution) is high, more and more mobile operators select LTE as an evolution direction for broadband wireless communication systems in future. LTE-based M2M multi-type data services will become more attractive.

Types of physical channels for downlinks of an LTE system include: Physical Control Format Indication Channels (PCFICHs) for bearing control area symbolic numbers, Physical HARQ Indication Channels (PHICHs) for bearing Hybrid Automatic Repeat Request Acknowledgement (HARQ-ACK) of uplink data, Physical Downlink Control Channels (PDCCHs) for bearing information such as downlink allocation, uplink granting and power control, and Physical Downlink Shared Channels (PDSCHs) for bearing service data and/or layer 3 control information. FIG. 1 is a schematic diagram of a multiplexing relationship between PDCCH and PDSCH in a downlink sub-frame in the related art. As shown in FIG. 1, PHCCH is transmitted in each sub-frame and has a time division multiplexing relationship with PDSCH. Specifically, PDCCH is transmitted through first X (its value is from 1 to 4) OFDM (Orthogonal Frequency Division Multiplexing) symbols of one sub-frame. A PDCCH consists of Y CCEs (Control Channel Elements), herein a value of Y is 1, 2, 4 or 8.

Types of physical channels of uplinks of the existing LTE system include: Physical Uplink Control Channels (PUCCHs) for bearing layer 1/layer 2 control information, and Physical Uplink Shared Channels (PUSCHs) for bearing various service data, layer 1/layer 2 control information and/or layer 3 control information, herein types of layer 1/layer 2 control information include Scheduling Request (SR), Channel State Information (CSI) and HARQ-ACK feedback of downlink data. According to contents of control information born by PUCCH, multiple PUCCH formats are divided. Specifically, a format for bearing SR is a PUCCH format 1, a format for bearing HARQ-ACK feedback is a PUCCH format 1a/1b, a format for bearing CSI is a PUCCH format 2, and a format for simultaneously bearing HARQ-ACK feedback and CSI is a PUCCH format 2a/2b.

Each sub-frame of the existing LTE system reserves at least one PUCCH resource for PUCCH, each PUCCH resource occupies two resource blocks respectively located in two time slots of a sub-frame, and the two resource blocks are respectively located in upper and lower sidebands of the system. As shown, FIG. 2 is a schematic diagram of mapping from PUCCH resources to Physical Resource Blocks (PRBs) in an uplink sub-frame in the related art. In FIG. 2, four PUCCH resources are reserved for PUCCH transmission and are respectively marked as m=0, 1, 2, 3, herein m denotes an index of PUCCH resource.

Different PUCCHs which belong to the same PUCCH resource multiplex together by means of code division, and PUCCHs which belong to different PUCCH resources multiplex together by means of time division and/or frequency division. Specifically, PUCCH format 1/1a/1b channels multiplex on a PUCCH resource by means of code division through cyclic shift of a constant-amplitude zero-autocorrelation sequence and an orthogonal block spread spectrum sequence, PUCCH format 2/2a/2b channels multiplex on a PUCCH resource by means of code division through cyclic shift of the constant-amplitude zero-autocorrelation sequence, and PUCCH format 1/1a/1b channels and PUCCH format 2/2a/2b channels can also multiplex on a PUCCH resource by means of code division through cyclic shift of the constant-amplitude zero-autocorrelation sequence.

The existing LTE system divides all PUCCH resources into multiple types, specifically including PUCCH resources for PUCCH format 2/2a/2b transmission only, PUCCH resources for PUCCH format 1/1a/1b transmission only, and PUCCH resources for both PUCCH format 1/1a/1b transmission and PUCCH format 2/2a/2b transmission (called as PUCCH hybrid resources). As shown, FIG. 3 is a schematic diagram of PUCCH resource type division in the related art. In FIG. 3, first N_{RB}⁽²⁾ PUCCH resources are only used for PUCCH format 2/2a/2b transmission, a next PUCCH resource is used for hybrid transmission of PUCCH format 2/2a/2b and PUCCH format 1/1a/1b, and other PUCCH resources are only used for PUCCH format 1/1a/1b transmission, herein m is an index of PUCCH resource, N_{RB}^{HO} denotes the total number of reserved PUCCH resources and N_{RB}⁽²⁾ denotes the number of PUCCH resources reserved for PUCCH format 2/2a/2b transmission only.

Through signaling, the existing LTE system can configure the number of PUCCH format 2/2a/2b channels included in a PUCCH format 2/2a/2b resource, the number of PUCCH format 1/1a/1b channels included in a PUCCH format 1/1a/1b resource, and the number of PUCCH format 1/1a/1b channels and the number of PUCCH format 2/2a/2b channels included in a hybrid PUCCH resource. As shown in FIG. 3, a starting point of PUCCH 2/2a/2b channels is located in a first reserved PUCCH resource and a starting point of PUCCH 1/1a/1b channels is located in a hybrid PUCCH resource indexed as N_{RB}⁽²⁾.

As described above, the existing LTE system transmits HARQ-ACK feedback information related to downlink service data through PUCCH format 1a/1b. In this situation, an index of the PUCCH format 1a/1b channel is implicitly determined according to an index of a first CCE resource occupied by PDCCH related to downlink allocation. In this implicit mapping process, an implicit mapping offset N_{PUCCH}⁽¹⁾ exists, i.e., indicating that first N_{PUCCH}⁽¹⁾ (indexed from 0 to N_{PUCCH}⁽¹⁾−1) channels in all PUCCH format 1/1a/1b channels will not be used for implicit mapping. In other words, it is not related to indexes of CCE resources occupied by PDCCH. After the index of the PUCCH format 1a/1b channel is determined, a terminal can determine an orthogonal block spread spectrum sequence index corresponding to the PUCCH format 1a/1b channel, a cyclic shift sequence index of the constant-amplitude zero-autocorrelation sequence and indexes of occupied PUCCH resources according to the index.

Since some MTC terminals may be installed in basements of dwellings or at positions which are blocked by aluminum alloy windows or traditional thick-wall building structures, compared with normal LTE terminals, these MTC terminals will have quite serious penetration losses at radio-frequency interfaces, and thus the coverage of MTC terminals needs to be enhanced. Therein, types of data which need to be enhanced include uplink and downlink service data for bearing PDSCH and PUSCH and uplink and downlink control signaling for bearing PDCCH and PUCCH. In order to accumulate more energy to improve the coverage, a repetitive transmission method is usually used for transmission enhancement of various types of data. FIG. 4 is schematic diagram of a coverage-enhanced downlink transmission process in the related art. In FIG. 4, oblique line shadow checkers denote PDCCHs, small square checker shadows denote PDSCHs and grey shadows denote PUCCHs. As shown in FIG. 4, downlink allocation information is repetitively transmitted through a PDCCH in a plurality of continuous downlink sub-frames, downlink service data are repetitively transmitted through a PDSCH in a plurality of continuous downlink sub-frames, and HARQ-ACK feedback information is repetitively transmitted through a PUCCH format 1a/1b channel in a plurality of continuous uplink sub-frames. Therein, a spacing between the last sub-frame occupied by the PDCCH and a starting sub-frame occupied by the PDSCH is total D₁ (D₁ is greater than 0) sub-frames, and a spacing between the last sub-frame occupied by the PDSCH and a starting sub-frame occupied by the PUCCH format 1a/1b channel is total three sub-frames.

Under the situation that the coverage-enhanced MTC terminal and the normal LTE terminal coexist, if both two types of terminals adopt a mapping rule of implicit PUCCH format 1a/1b channels related to an index of a first CCE occupied by the PDCCH in the related art, a problem of conflict between HARQ-ACK feedback of the coverage-enhanced MTC terminal and the HARQ-ACK of the normal LTE terminal will exist. Specifically, FIG. 5 is a schematic diagram of conflict between a PUCCH format 1a/1b channel of a coverage-enhanced terminal and a PUCCH format 1a/1b channel of a normal LTE terminal in the related art. In FIG. 5, oblique line shadow checkers denote PDCCH and small grey shadows denote PUCCHs. As shown in FIG. 5, a first sub-frame (marked as sub-frame j) in a plurality of sub-frames for transmitting HARQ-ACK feedback information from the coverage-enhanced MTC terminal through the PUCCH format 1a/1b channel is also a sub-frame for transmitting HARQ-ACK feedback information from the normal LTE terminal. If an index of a first CCE occupied by the PDCCH of the coverage-enhanced MTC terminal is the same as an index of a first CCE occupied by the PDCCH of the normal LTE terminal, in the sub-frame j, indexes of PUCCH format 1a/1b channels for bearing the HARQ-ACK feedback information of the coverage-enhanced MTC terminal and the normal LTE terminal are also the same, consequently resulting in a channel conflict. In addition, in addition to the sub-frame j, other sub-frames for transmitting the HARQ-ACK feedback information may also have the similar conflict problem.

For the coverage-enhanced MTC terminal, the related art supports simultaneous transmission of HARQ-ACK feedback information of downlink service data and uplink service data. Specifically, the HARQ-ACK feedback information and the uplink service data are respectively born in determined PUCCH format 1a/1b and PUSCH resources and then are transmitted, or the HARQ-ACK feedback information and the uplink service data share the same PUSCH resource, and are simultaneously born in the determined PUSCH resource and then are transmitted. However, since the transmitting power of the coverage-enhanced MTC terminal is limited and is simultaneously allocated to the HARQ-ACK feedback information and the uplink service data at this moment, the receiving energy of the HARQ-ACK feedback information is caused to be decreased and finally the coverage performance of the HARQ-ACK feedback is influenced.

### SUMMARY

In order to solve the technical problem, the embodiments of the present document provides a transmission method and system for HARQ-ACK feedback information, a terminal and a base station, which can prevent the problem of channel conflict under the situation that a coverage-enhanced MTC terminal and a normal LTE terminal coexist.

A transmission method for Hybrid Automatic Repeat Request Acknowledgement (HARQ-ACK) feedback information includes: when a base station determines that a terminal is in a coverage-enhanced scenario,

determining, by the base station, a Physical Uplink Control Channel (PUCCH) corresponding to the terminal according to a preset transmission policy, herein the transmission policy is: transmitting, by the base station, PUCCH indication signaling to the terminal, the indication signaling carrying information of one PUCCH of preset N PUCCHs, the one PUCCH being a PUCCH corresponding to the terminal, herein N is a positive integer greater than or equal to 2; or determining a PUCCH corresponding to the terminal according to preset resources; or determining a preset terminal-specific PUCCH to be a PUCCH corresponding to the terminal; and

receiving, by the base station, HARQ-ACK feedback information from the terminal through the PUCCH corresponding to the terminal.

More preferably, the PUCCH is a PUCCH format 1/1a/1b channel or a PUCCH format 2/2a/2b channel.

More preferably, the transmission policy is: transmitting, by the base station, PUCCH indication signaling to the terminal, when the indication signaling carries information of one PUCCH of preset N PUCCHs, the preset N PUCCHs being continuous or discontinuous.

More preferably, when the PUCCH is the PUCCH format 1/1a/1b channel, a first PUCCH of the preset N PUCCHs is a PUCCH format 1/1a/1b channel indexed as 0; or a PUCCH format 1/1a/1b channel indexed as N_{PUCCH}⁽¹⁾−1; or a PUCCH format 1/1a/1b channel indexed as Q⁽¹⁾, herein Q⁽¹⁾ is a number of PUCCH format 1/1a/1b channels included in hybrid PUCCH resources indexed as N_{RB}⁽²⁾.

More preferably, when the PUCCH is the PUCCH format 2/2a/2b channel, a first PUCCH of the preset N PUCCHs is a PUCCH format 2/2a/2b channel indexed as 0; or a PUCCH format 2/2a/2b channel indexed as N_{PUCCH,max}⁽²⁾−1 herein N_{PUCCH,max}⁽²⁾ is a total number of PUCCH format 2/2a/2b channels; or a PUCCH format 2/2a/2b channel indexed as N_{PUCCH,max}⁽²⁾−Q⁽²⁾−1, herein Q⁽²⁾ is a number of PUCCH format 2/2a/2b channels included in hybrid PUCCH resources indexed as N_{RB}⁽²⁾.

More preferably, when the PUCCHs are discontinuous PUCCH format 1/1a/1b channels, a spacing between two adjacent PUCCHs of the preset N PUCCHs is determined according to at least one of the following parameters:

a number N of the preset PUCCHs, an implicit mapping offset N_{PUCCH}⁽¹⁾ and a number Q⁽¹⁾ of PUCCH format 1/1a/1b channels included in hybrid PUCCH resources indexed as N_{RB}⁽²⁾.

More preferably, when the PUCCHs are discontinuous PUCCH format 2/2a/2b channels, a spacing between two adjacent PUCCHs of the preset N PUCCHs is determined according to at least one of the following parameters:

a number N of the preset PUCCHs, a total number N_{PUCCH,max}⁽²⁾ of PUCCH format 2/2a/2b channels, and a number Q⁽²⁾ of PUCCH format 2/2a/2b channels included in hybrid PUCCH resources indexed as N_{RB}⁽²⁾.

More preferably, the indication signaling includes:

Downlink Control Information (DCI) signaling born in a Physical Downlink Control Channel (PDCCH) or Radio Resource Control (RRC) signaling born in a Physical Downlink Shared Channel (PDSCH).

More preferably, a bit number of the indication signaling is ceiling (log₂N), herein ceiling denotes an operation of rounding up to integer.

More preferably, the RRC signaling includes signaling born in Msg2 or Msg4 related to a random access process; and

the RRC signaling is semi-static configuration signaling.

More preferably, the DCI signaling includes DCI signaling for indicating a PUCCH for transmitting HARQ-ACK feedback information or DCI signaling for resource allocation of PDSCHs;

a DCI format is a proprietary DCI format of the coverage-enhanced terminal; and

the DCI signaling is dynamic configuration signaling.

More preferably, the transmission policy is: determining a PUCCH corresponding to the terminal according to preset resources; and

the preset resources include at least one of follows:

Control Channel Elements (CCEs) occupied by PDCCH, a number of CCEs occupied by PDCCH, sub-frames occupied by PDCCH, a number of sub-frames occupied by PDCCH, sub-frames occupied by PUCCH, a number of sub-frames occupied by PUCCH, sub-frames occupied by PDSCH, a number of sub-frames occupied by PDSCH, Physical Resource Blocks (PRBs) occupied by PDSCH, a number of PRBs occupied by PDSCH and an identification of the terminal.

More preferably, the step of determining a PUCCH corresponding to the terminal according to preset resources includes:

acquiring a reference PUCCH;

determining a PUCCH offset according to the acquired reference PUCCH and the preset resources; and

calculating a sum of an index of the reference PUCCH and the PUCCH offset, herein the sum value is a PUCCH index.

More preferably, when the PUCCH is the PUCCH format 1/1a/1b, the reference PUCCH includes:

a PUCCH format 1/1a/1b channel indexed as 0;

or a PUCCH format 1/1a/1b channel indexed as N_{PUCCH}⁽¹⁾−1; or a PUCCH format 1/1a/1b channel indexed as Q⁽¹⁾.

More preferably, when the PUCCH is the PUCCH format 2/2a/2b, the reference PUCCH includes:

a PUCCH format 2/2a/2b channel indexed as 0;

or a PUCCH format 2/2a/2b channel indexed as N_{PUCCH,max}⁽²⁾−1, or a PUCCH format 2/2a/2b channel indexed as N_{PUCCH,max}⁽²⁾−Q⁽²⁾−1.

More preferably, the step of determining a PUCCH offset according to the acquired reference PUCCH and the preset resources includes:

determining a direction of the PUCCH offset according to the acquired reference PUCCH; and

determining a magnitude of the PUCCH offset according to the preset resources.

More preferably, the step of determining a direction of the PUCCH offset according to the acquired reference PUCCH includes:

when the acquired reference PUCCH is a PUCCH format 1/1a/1b channel indexed as 0, or a PUCCH format 2/2a/2b channel indexed as 0 or a PUCCH format 1/1a/1b channel indexed as Q⁽¹⁾, determining the direction of the PUCCH offset to be positive; and

when the acquired reference PUCCH is a PUCCH format 1/1a/1b channel indexed as N_{PUCCH}⁽¹⁾−1, or a PUCCH format 2/2a/2b channel indexed as N_{PUCCH,max}⁽²⁾−1 or a PUCCH format 2/2a/2b channel indexed as N_{PUCCH,max}⁽²⁾−Q⁽²⁾−1, determining the direction of the PUCCH offset to be negative.

More preferably, the step of determining a magnitude of the PUCCH offset according to the preset resources includes:

determining the magnitude of the PUCCH offset according to an index of a first sub-frame occupied by the PDCCH; or according to an index of a first CCE occupied by the PDCCH and the number of the CCEs; or according to the number of the sub-frames occupied by the PDCCH; or according to the index of the first CCE occupied by the PDCCH, the index of the first sub-frame, the number of the CCEs and the number of the sub-frames; or according to the number of the sub-frames occupied by the PUCCH; or according to the number of the sub-frames occupied by the PDSCH; or according to the identification of the terminal.

More preferably, the transmission policy is determining a preset terminal-specific PUCCH to be a PUCCH corresponding to the terminal, including:

a PUCCH format 1/1a/1b channel indexed as 0;

or a PUCCH format 1/1a/1b channel indexed as N_{PUCCH}⁽¹⁾−1; or a PUCCH format 1/1a/1b channel indexed as Q⁽¹⁾; or a PUCCH format 2/2a/2b channel indexed as 0; or a PUCCH format 2/2a/2b channel indexed as N_{PUCCH,max}⁽²⁾−1; or a PUCCH format 2/2a/2b channel indexed as N_{PUCCH,max}⁽²⁾−Q⁽²⁾−1.

More preferably, when the HARQ-ACK feedback information and service data are transmitted on a same sub-frame, the method further includes:

receiving, by the base station, the HARQ-ACK feedback information through the determined PUCCH or PUSCH resources bearing the service data.

More preferably, the step of receiving the HARQ-ACK feedback information through PUSCH resources bearing the service data includes:

receiving the HARQ-ACK feedback information according to a way of transmitting service data through the PUSCH;

or selecting a PRB pair from resources corresponding to the PUSCH bearing the service data, and receiving the HARQ-ACK feedback information by means of a PUCCH format 1a/1b.

More preferably, the method further includes:

receiving, by the base station, the service data according to a number of sub-frames after addition;

or after the service data are transmitted, receiving the service data according to a way of adaptively repetitively transmitting;

or according to a number of sub-frames for simultaneously transmitting the HARQ-ACK feedback information and the service data, determining whether to receive the service data according to the way of adaptively repetitively transmitting after the service data are transmitted.

A transmission method for Hybrid Automatic Repeat Request Acknowledgement (HARQ-ACK) feedback information includes: when a terminal is in a coverage-enhanced scenario,

determining, by the terminal, a Physical Uplink Control Channel (PUCCH) corresponding to the terminal according to a preset transmission policy, herein the transmission policy is: receiving, by the terminal, PUCCH indication signaling from the a base station, the indication signaling carrying information of one PUCCH of preset N PUCCHs, the one PUCCH being a PUCCH corresponding to the terminal, herein N is a positive integer greater than or equal to 2; or determining a PUCCH corresponding to the terminal according to preset resources; or determining a preset terminal-specific PUCCH to be a PUCCH corresponding to the terminal; and

transmitting, by the terminal, HARQ-ACK feedback information through the determined PUCCH.

More preferably, the PUCCH is a PUCCH format 1/1a/1b channel or a PUCCH format 2/2a/2b channel.

More preferably, the transmission policy is: receiving, by the terminal, PUCCH indication signaling from the base station, when the indication signaling carries information of one PUCCH of preset N PUCCHs, the preset N PUCCHs being continuous or discontinuous.

More preferably, when the PUCCH is the PUCCH format 1/1a/1b channel,

a first PUCCH of the preset N PUCCHs is a PUCCH format 1/1a/1b channel indexed as 0; or a PUCCH format 1/1a/1b channel indexed as N_{PUCCH}⁽¹⁾−1; or a PUCCH format 1/1a/1b channel indexed as Q⁽¹⁾, herein Q⁽¹⁾ is a number of PUCCH format 1/1a/1b channels included in hybrid PUCCH resources indexed as N_{RB}⁽²⁾.

More preferably, when the PUCCH is the PUCCH format 2/2a/2b channel,

a first PUCCH of the preset N PUCCHs is a PUCCH format 2/2a/2b channel indexed as 0; or a PUCCH format 2/2a/2b channel indexed as N_{PUCCH,max}⁽²⁾−1, herein N_{PUCCH,max}⁽²⁾ is a total number of PUCCH format 2/2a/2b channels; or a PUCCH format 2/2a/2b channel indexed as N_{PUCCH,max}⁽²⁾−Q⁽²⁾−1, herein Q⁽²⁾ is a number of PUCCH format 2/2a/2b channels included in hybrid PUCCH resources indexed as N_{RB}⁽²⁾.

More preferably, when the PUCCHs are discontinuous PUCCH format 1/1a/1b channels, a spacing between two adjacent PUCCHs of the preset N PUCCHs is determined according to at least one of the following parameters:

a number N of the preset PUCCHs, an implicit mapping offset N_{PUCCH}⁽¹⁾ and a number Q⁽¹⁾ of PUCCH format 1/1a/1b channels included in hybrid PUCCH resources indexed as N_{RB}⁽²⁾.

More preferably, when the PUCCHs are discontinuous PUCCH format 2/2a/2b channels, a spacing between two adjacent PUCCHs of the preset N PUCCHs is determined according to at least one of the following parameters:

a number N of the preset PUCCHs, a total number N_{PUCCH,max}⁽²⁾ of PUCCH format 2/2a/2b channels, and a number Q⁽²⁾ of PUCCH format 2/2a/2b channels included in hybrid PUCCH resources indexed as N_{RB}⁽²⁾.

More preferably, the indication signaling includes:

Downlink Control Information (DCI) signaling born in a Physical Downlink Control Channel (PDCCH) or Radio Resource Control (RRC) signaling born in a Physical Downlink Shared Channel (PDSCH).

More preferably, a bit number of the indication signaling is ceiling (log₂N), herein ceiling denotes an operation of rounding up to integer.

More preferably, the RRC signaling includes signaling born in Msg2 or Msg4 related to a random access process; and the RRC signaling is semi-static configuration signaling.

More preferably, the DCI signaling includes DCI signaling for indicating a PUCCH for transmitting HARQ-ACK feedback information or DCI signaling for resource allocation of PDSCHs;

a DCI format is a proprietary DCI format of the coverage-enhanced terminal; and

the DCI signaling is dynamic configuration signaling.

More preferably, the transmission policy is: determining a PUCCH corresponding to the terminal according to preset resources; and the preset resources include at least one of follows:

Control Channel Elements (CCEs) occupied by PDCCH, a number of CCEs occupied by PDCCH, sub-frames occupied by PDCCH, a number of sub-frames occupied by PDCCH, sub-frames occupied by PUCCH, a number of sub-frames occupied by PUCCH, sub-frames occupied by PDSCH, a number of sub-frames occupied by PDSCH, Physical Resource Blocks (PRBs) occupied by PDSCH, a number of PRBs occupied by PDSCH and an identification of the terminal.

More preferably, the step of determining a PUCCH corresponding to the terminal according to preset resources includes:

acquiring a reference PUCCH;

determining a PUCCH offset according to the acquired reference PUCCH and the preset resources; and

calculating a sum of an index of the reference PUCCH and the PUCCH offset, herein the sum value is a PUCCH index.

More preferably, when the PUCCH is the PUCCH format 1/1a/1b, the reference PUCCH includes:

a PUCCH format 1/1a/1b channel indexed as 0;

or a PUCCH format 1/1a/1b channel indexed as N_{PUCCH}⁽¹⁾−1; or a PUCCH format 1/1a/1b channel indexed as Q⁽¹⁾.

More preferably, when the PUCCH is the PUCCH format 2/2a/2b, the reference PUCCH includes:

a PUCCH format 2/2a/2b channel indexed as 0;

or a PUCCH format 2/2a/2b channel indexed as N_{PUCCH,max}⁽²⁾−1; or a PUCCH format 2/2a/2b channel indexed as N_{PUCCH,max}⁽²⁾−Q⁽²⁾−1.

More preferably, the step of determining a PUCCH offset according to the acquired reference PUCCH and the preset resources includes:

determining a direction of the PUCCH offset according to the acquired reference PUCCH;

and determining a magnitude of the PUCCH offset according to the preset resources.

More preferably, the step of determining a direction of the PUCCH offset according to the acquired reference PUCCH includes:

when the acquired reference PUCCH is a PUCCH format 1/1a/1b channel indexed as 0, or a PUCCH format 2/2a/2b channel indexed as 0 or a PUCCH format 1/1a/1b channel indexed as Q⁽¹⁾, determining the direction of the PUCCH offset to be positive; and when the acquired reference PUCCH is a PUCCH format 1/1a/1b channel indexed as N_{PUCCH}⁽¹⁾−1, or a PUCCH format 2/2a/2b channel indexed as N_{PUCCH,max}⁽²⁾−1 or a PUCCH format 2/2a/2b channel indexed as N_{PUCCH,max}⁽²⁾−Q⁽²⁾−1, determining the direction of the PUCCH offset to be negative.

More preferably, the step of determining a magnitude of the PUCCH offset according to the preset resources includes:

determining the magnitude of the PUCCH offset according to an index of a first sub-frame occupied by the PDCCH; or according to an index of a first CCE occupied by the PDCCH and the number of the CCEs; or according to the number of the sub-frames occupied by the PDCCH; or according to the index of the first CCE occupied by the PDCCH, the index of the first sub-frame, the number of the CCEs and the number of the sub-frames; or according to the number of the sub-frames occupied by the PUCCH; or according to the number of the sub-frames occupied by the PDSCH; or according to the identification of the terminal.

More preferably, the transmission policy is determining a preset terminal-specific PUCCH to be a PUCCH corresponding to the terminal, including:

a PUCCH format 1/1a/1b channel indexed as 0;

or a PUCCH format 1/1a/1b channel indexed as N_{PUCCH}⁽¹⁾−1; or a PUCCH format 1/1a/1b channel indexed as Q⁽¹⁾; or a PUCCH format 2/2a/2b channel indexed as 0; or a PUCCH format 2/2a/2b channel indexed as N_{PUCCH,max}⁽²⁾−1; or a PUCCH format 2/2a/2b channel indexed as N_{PUCCH,max}⁽²⁾−Q⁽²⁾−1.

More preferably, when the HARQ-ACK feedback information and service data are transmitted on a same sub-frame, the method further includes:

canceling, by the terminal, the transmission of the service data, and transmitting the HARQ-ACK feedback information through the determined PUCCH or PUSCH resources bearing the service data.

More preferably, the step of transmitting the HARQ-ACK feedback information through the PUSCH resources bearing the service data includes:

transmitting the HARQ-ACK feedback information according to a way of transmitting service data through the PUSCH;

or selecting a PRB pair from resources corresponding to the PUSCH bearing the service data, and transmitting the HARQ-ACK feedback information by means of a PUCCH format 1a/1b.

More preferably, the method further includes:

transmitting, by the terminal, the service data according to a number of sub-frames after addition;

or after the service data are transmitted, adaptively repetitively transmitting the service data;

or according to a number of sub-frames for simultaneously transmitting the HARQ-ACK feedback information and the service data, determining whether to adaptively repetitively transmitting the service data after the service data are transmitted.

A transmission system for Hybrid Automatic Repeat Request Acknowledgement (HARQ-ACK) feedback information at least includes a base station and a terminal, herein, the base station is configured to, when determining that the terminal is in a coverage-enhanced scenario, determine a Physical Uplink Control Channel (PUCCH) corresponding to the terminal according to a preset transmission policy; and receive HARQ-ACK feedback information through the PUCCH corresponding to the terminal; and the terminal is configured to determine a PUCCH corresponding to the terminal according to a preset transmission policy; and transmit HARQ-ACK feedback information through the determined PUCCH;

herein the transmission policy is:

transmitting, by the base station, PUCCH indication signaling to the terminal, the indication signaling carrying information of one PUCCH of preset N PUCCHs, the one PUCCH being a PUCCH corresponding to the terminal, herein N is a positive integer greater than or equal to 2;

or determine a PUCCH corresponding to the terminal according to preset resources;

or determine a preset terminal-specific PUCCH to be a PUCCH corresponding to the terminal.

More preferably, the base station at least includes a determining module, a first processing module and a first receiving module, herein, the determining module is configured to, when determining that the terminal is in a coverage-enhanced scenario, notify the first processing module;

the first processing module is configured to determine the PUCCH corresponding to the terminal according to the preset transmission policy; and

the first receiving module is configured to receive the HARQ-ACK feedback information from the terminal through the PUCCH corresponding to the terminal; and

the terminal at least includes a second processing module and a second transmitting module, herein, the second processing module is configured to determine the PUCCH corresponding to the terminal according to the preset transmission policy; and the second transmitting module is configured to transmit the HARQ-ACK feedback information through the determined PUCCH.

More preferably, the base station further includes a first transmitting module configured to receive a notification from the first processing module and transmit PUCCH indication information to the terminal; and correspondingly,

the terminal further includes a second receiving module configured to receive the indication signaling from the base station and output the indication signaling to the second processing module.

A base station includes a determining module, a first processing module and a first receiving module, herein,

the determining module is configured to, when determining that a terminal is in a coverage-enhanced scenario, notify the first processing module;

the first processing module is configured to determine a PUCCH corresponding to the terminal according to a preset transmission policy; and

the first receiving module is configured to receive HARQ-ACK feedback information from the terminal through the PUCCH corresponding to the terminal.

More preferably, the base station further includes a first transmitting module configured to receive a notification from the first processing module and transmit PUCCH indication information to the terminal.

A terminal, in a coverage-enhanced scenario, at least includes a second processing module and a second transmitting module, herein, the second processing module is configured to determine a PUCCH corresponding to the terminal according to a preset transmission policy; and the second transmitting module is configured to transmit HARQ-ACK feedback information through the determined PUCCH.

More preferably, the terminal further includes a second receiving module configured to receive indication signaling from a base station and output the indication signaling to the second processing module.

A computer program includes program instructions, which, when executed by a base station, enable the base station to execute the above mentioned method.

A computer program includes program instructions, which, when executed by a terminal, enable the terminal to execute the above mentioned method.

A carrier carrying any one of the above mentioned computer programs is provided.

In the methods of the embodiments of the present document, by configuring the proprietary PUCCHs or candidate PUCCH resources for transmitting the HARQ-ACK feedback for the terminal in a coverage-enhanced mode or scenario, the conflict between the HARQ-ACK feedback channels of the coverage-enhanced terminal and the normal LTE terminal is avoided.

In addition, when the HARQ-ACK feedback information and the service data are transmitted on the same sub-frame, the terminal cancels the transmission of the service data and transmits the HARQ-ACK feedback information through the PUCCH determined according to the methods of the embodiments of the present document or the PUSCH channel resources bearing the service data; and simultaneously the service data is adaptively repetitively transmitted. Hence, the coverage performance of the HARQ-ACK feedback is guaranteed.

### BRIEF DESCRIPTION OF DRAWINGS

The drawings described here are used for providing further understanding about the present document and constitute a part of the present application. The exemplary embodiments of the present document and the description thereof are used for explaining the present document instead of improperly limiting the present document. In the drawings,

FIG. 1 is a schematic diagram of a multiplexing relationship between PDCCH and PDSCH in a downlink sub-frame in the related art;

FIG. 2 is a schematic diagram of mapping from PUCCH resources to physical resource blocks in an uplink sub-frame in the related art;

FIG. 3 is a schematic diagram of PUCCH resource type division in the related art;

FIG. 4 is a schematic diagram of a coverage-enhanced downlink transmission process in the related art;

FIG. 5 is a schematic diagram of conflict between a PUCCH format 1a/1b channel of a coverage-enhanced terminal and a PUCCH format 1a/1b channel of a normal LTE terminal in the related art;

FIG. 6 is a flowchart of a transmission method for HARQ-ACK feedback information provided by the embodiment of the present document;

FIG. 7 is a schematic diagram of a component structure of a transmission system for HARQ-ACK feedback information provided by the embodiment of the present document;

FIG. 8 is a schematic diagram of positions of preset N PUCCHs in embodiment 1 of the present document;

FIG. 9 is a schematic diagram of positions of preset N PUCCHs in embodiment 2 of the present document;

FIG. 10 is a schematic diagram of sub-frame and CCE resources occupied by a PDCCH in the embodiment of the present document;

FIG. 11 is a schematic diagram of transmission of HARQ-ACK feedback information through uplink sub-frames with service data transmission in embodiment 9 of the present document;

FIG. 12 is a schematic diagram of transmission of HARQ-ACK feedback information through uplink sub-frames with service data transmission in embodiment 10 of the present document.

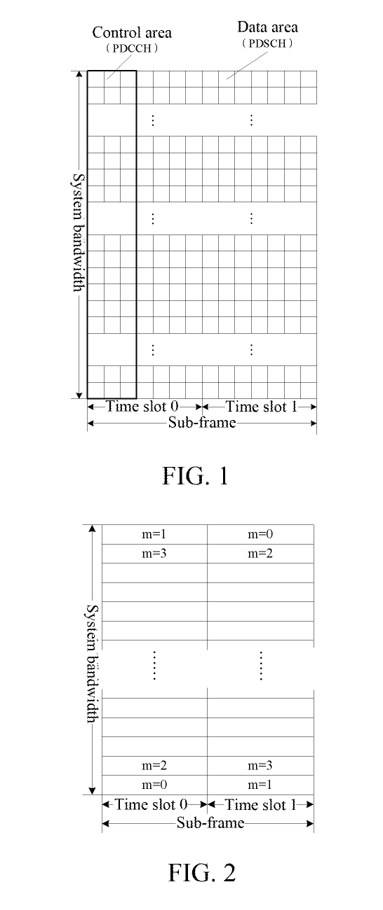

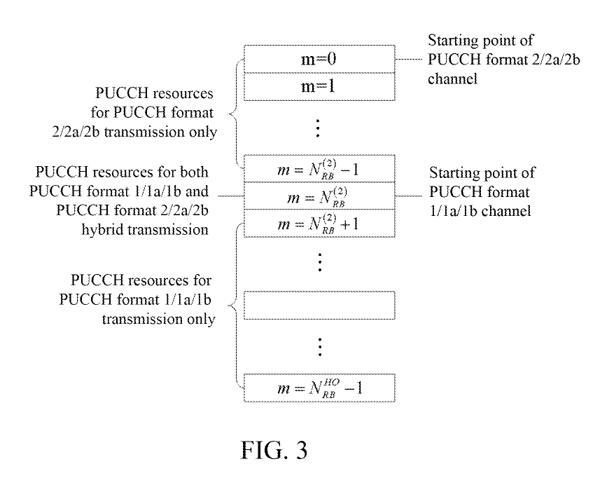

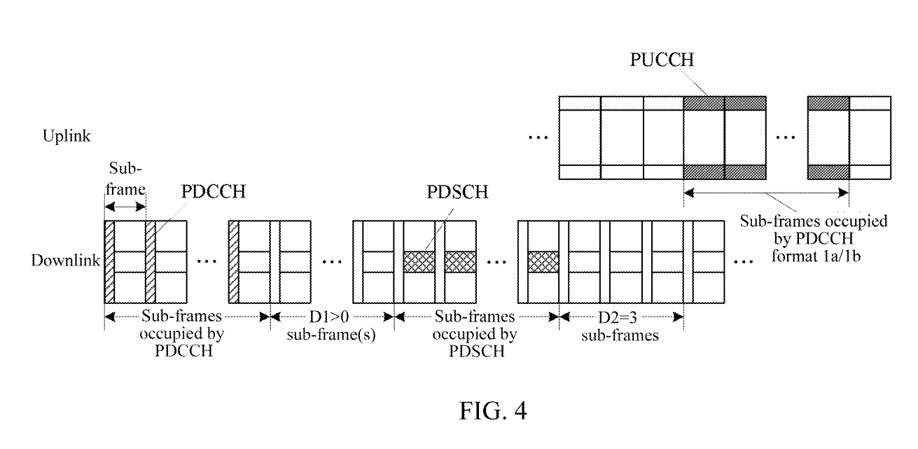

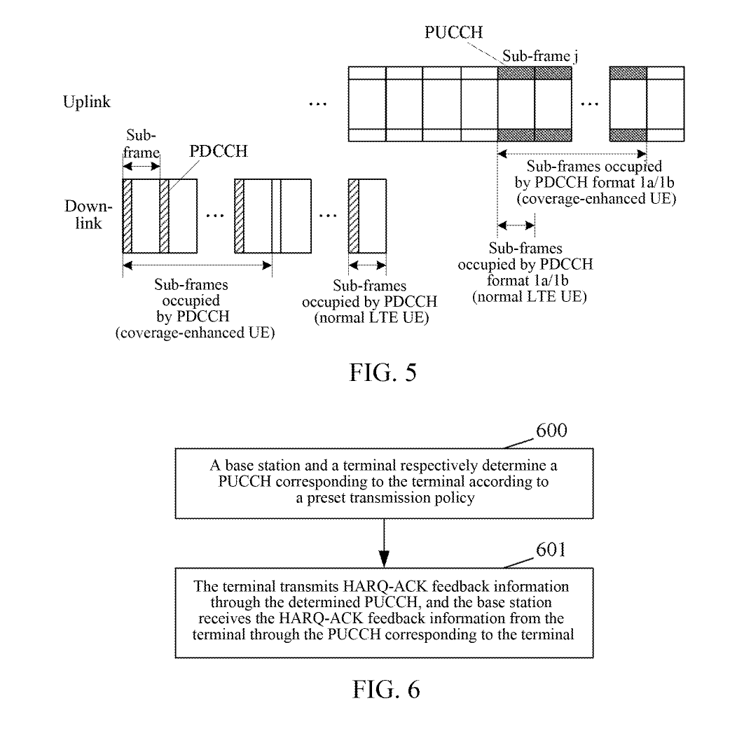

### PREFERRED EMBODIMENTS

The embodiments of the present document will be described below in detail in combination with the drawings. It needs to be stated that the embodiments in the present application and the features in the embodiments can be freely combined under the situation of no conflict.

FIG. 6 is a flowchart of a transmission method for HARQ-ACK feedback information provided by the embodiment of the present document. As shown in FIG. 6, when a base station determines that a terminal is in a coverage-enhanced scenario, the method further includes the following steps:

In Step 600, a base station and a terminal respectively determine a PUCCH corresponding to the terminal according to a preset transmission policy, herein, the transmission policy can be:

the base station transmits PUCCH indication signaling to the terminal, the indication signaling carries information of one PUCCH of preset N PUCCHs, the PUCCH is a PUCCH corresponding to the terminal, herein N is a positive integer greater than or equal to 2;

or determine a PUCCH corresponding to the terminal according to preset resources;

or determine a preset terminal-specific PUCCH to be a PUCCH corresponding to the terminal.

In this step, the terminal is in the coverage-enhanced scenario under the following situations:

the terminal is defaulted or always works in a coverage-enhanced mode;

or by measuring receiving power or receiving quality when a reference signal or a synchronizing signal transmitted by the base station reaches the terminal, the terminal judges that the receiving power or the receiving quality is lower than a determined threshold, and the terminal enables the coverage-enhanced mode.

In this step, the PUCCH can be a PUCCH format 1/1a/1b channel or a PUCCH format 2/2a/2b channel. Therefore, corresponding operations can be executed subsequently according to different PUCCH formats, i.e., different PUCCH formats correspond to different operations.

In this step, when the transmission policy is that: the base station transmits PUCCH indication signaling to the terminal, when the indication signaling carries information of one PUCCH of preset N PUCCHs (N is a positive integer greater than or equal to 2), the PUCCH is a PUCCH corresponding to the terminal:

the preset N PUCCHs can be continuous or discontinuous.

More preferably, when the PUCCH is the PUCCH format 1/1a/1b channel, the preset N PUCCHs are N PUCCH format 1/1a/1b channels of N_{PUCCH}⁽¹⁾ PUCCH format 1/1a/1b channels indexed from 0 to N_{PUCCUC}⁽¹⁾−1, and the first PUCCH of the preset N PUCCHs is a PUCCH 1/1a/1b channel indexed as 0; or a PUCCH format 1/1a/1b channel indexed as N_{PUCCH}⁽¹⁾−1; or a PUCCH format 1/1a/1b channel indexed as Q⁽¹⁾, herein Q⁽¹⁾ is the number of PUCCH format 1/1a/1b channels included in hybrid PUCCH resources indexed as N_{RB}⁽²⁾.

Here, since the N_{PUCCH}⁽¹⁾ PUCCH format 1/1a/1b channels indexed from 0 to N_{PUCCH}⁽¹⁾−1 are not used for an implicit PUCCH mapping process related to HARQ-ACK feedback of a normal LTE terminal, i.e., it is not related to indexes of CCEs occupied by the PDCCH of the normal LTE terminal, the embodiment of the present document selects the preset N PUCCHs from the N_{PUCCH}⁽¹⁾ PUCCH format 1/1a/1b channels as candidate PUCCHs for transmitting

HARQ-ACK feedback of the coverage-enhanced terminal, and thus the mutual conflict between the HARQ-ACK feedback channels of the coverage-enhanced terminal and the normal LTE terminal is avoided.

More preferably, when the PUCCH is the PUCCH format 2/2a/2b channel, the preset N PUCCHs are N PUCCH format 2/2a/2b channels of all PUCCH format 2/2a/2b channels, and the first PUCCH of the preset N PUCCHs is a PUCCH format 2/2a/2b channel indexed as 0; or a PUCCH format 2/2a/2b channel indexed as N_{PUCCH,max}⁽²⁾−1, herein N_{PUCCH,max}⁽²⁾ is a total number of PUCCH format 2/2a/2b channels; or a PUCCH format 2/2a/2b channel indexed as N_{PUCCH,max}⁽²⁾−Q⁽²⁾−1, herein Q⁽²⁾ is the number of PUCCH format 2/2a/2b channels included in hybrid PUCCH resources indexed as N_{RB}⁽²⁾.

In the existing LTE system, PUCCH format 1/2a/2b channels are not used for transmitting the HARQ-ACK feedback information. Therefore, the embodiment of the present document selects the preset N PUCCHs from the N_{PUCCH,max}⁽²⁾ PUCCH format 2/2a/ab channels as candidate PUCCHs for transmitting the HARQ-ACK feedback of the coverage-enhanced terminal, and thus the mutual conflict between the HARQ-ACK feedback channels of the coverage-enhanced terminal and the normal LTE terminal is also avoided.

More preferably, when the preset N PUCCHs are discontinuous PUCCH format 1/1a/1b channels, a spacing between two adjacent PUCCHs of the preset N PUCCHs is determined according to at least one of the following parameters:

the number N of the preset PUCCHs, an implicit mapping offset N_{PUCCH}⁽¹⁾ and the number Q⁽¹⁾ of PUCCH format 1/1a/1b channels included in hybrid PUCCH resources indexed as N_{RB}⁽²⁾.

For example, the spacing between two adjacent PUCCHs of the preset N PUCCHs can be determined by using a formula (1) or (2):

$$\begin{matrix}I = ceiling ( \frac{{N}_{PUCCH}^{( 1 )}}{N - 1} ) - 1 & ( 1 ) \\ I = ceiling ( \frac{{N}_{PUCCH}^{( 1 )} - {Q}^{( 1 )}}{N - 1} ) - 1 & ( 2 )\end{matrix}$$

In formula (1) or (2), I denotes the spacing between two adjacent PUCCHs and ceiling denotes an operation of rounding up to integer.

By the way of determining the PUCCHs through formula (1) or (2), the preset N PUCCHs can be uniformly scattered in N_{PUCCH}⁽¹⁾ PUCCH format 1/1a/1b channels indexed from 0 to N_{PUCCH}⁽¹⁾−1 or in N_{PUCCH}⁽¹⁾-Q⁽¹⁾ PUCCH format 1/1a/1b channels indexed from Q⁽¹⁾ to N_{PUCCH}⁽¹⁾−1, the situation that different channels of the preset N PUCCHs multiplex on the same

PUCCH resources by means of code division is avoided, thus the mutual interference between the HARQ-ACK feedback channels of different coverage-enhanced terminals is reduced and finally the coverage performance of the HARQ-ACK feedback information is improved.

More preferably, when the preset N PUCCHs are discontinuous PUCCH format 2/2a/2b channels, a spacing between two adjacent PUCCHs of the preset N PUCCHs is determined according to at least one of the following parameters:

the number N of the preset PUCCHs, the total number N_{PUCCH,max}⁽²⁾ of PUCCH format 2/2a/2b channels and the number Q⁽²⁾ of PUCCH format 2/2a/2b channels included in hybrid PUCCH resources indexed as N_{RB}⁽²⁾.

For example, the spacing between two adjacent PUCCHs of the preset N PUCCHs can be determined by using a formula (3) or (4):

$$\begin{matrix}I = ceiling ( \frac{{N}_{PUCCH , max}^{( 2 )}}{N - 1} ) - 1 & ( 3 ) \\ I = ceiling ( \frac{{N}_{PUCCH , max}^{( 2 )} - {Q}^{( 2 )}}{N - 1} ) - 1 & ( 4 )\end{matrix}$$

In formula (3) or (4), I denotes the spacing between two adjacent PUCCHs and ceiling denotes an operation of rounding up to integer.

By the way of determining the PUCCHs through formula (3) or (4), the preset N PUCCHs can be uniformly scattered in N_{PUCCH,max}⁽²⁾ PUCCH format 2/2a/ab channels indexed from 0 to N_{PUCCH,max}⁽²⁾−1 or in N_{PUCCH,max}⁽²⁾−Q⁽²⁾ PUCCH format 2/2a/2b channels indexed from 0 to N_{PUCCH,max}⁽²⁾−Q⁽²⁾−1, the situation that different channels of the preset N PUCCHs multiplex on the same PUCCH resources by means of code division is avoided, thus the mutual interference between the HARQ-ACK feedback channels of different coverage-enhanced terminals is reduced and the coverage performance of the HARQ-ACK feedback is improved.

In this step, the indication signaling is:

Downlink Control Information (DCI) signaling born in a Physical Downlink Control Channel (PDCCH) or Radio Resource Control (RRC) signaling born in a Physical Downlink Shared Channel (PDSCH), wherein the RRC signaling born in the PDSCH includes signaling born in Msg2 or Msg4 related to a random access process.

Therein, the DCI signaling includes DCI signaling for indicating a PUCCH for transmitting HARQ-ACK feedback information or DCI signaling for resource allocation of PDSCHs; and a DCI format is a proprietary DCI format of the coverage-enhanced terminal.

Therein, the DCI signaling is dynamic configuration signaling, i.e., before each time of executing PDSCH transmission, the terminal needs to firstly decode the DCI signaling related to this PDSCH transmission from the PDCCH to acquire the resource allocation information for this PDSCH transmission and a PUCCH position for transmitting the HARQ-ACK feedback information.

Therein, the RRC signaling is semi-static configuration signaling, i.e., after the terminal receives the RRC signaling for indicating the PUCCH for transmitting the HARQ-ACK feedback, the HARQ-ACK feedback related to all PDSCH transmission is transmitted on the PUCCH indicated by the RRC signaling, till the terminal receives new RRC signaling for indicating the PUCCH for transmitting the HARQ-ACK feedback information.

In this step, the indication signaling includes a ceiling (log₂N) bit number, wherein ceiling denotes an operation of rounding up to integer.

Through the transmission way of the indication signaling in the embodiment of the present document, the allocation flexibility of the preset N PUCCHs is increased, the reduction and the avoidance of interference with the HARQ-ACK feedback are facilitated, and the coverage performance of the HARQ-ACK feedback is improved.

In this step, when the transmission policy is “determining a PUCCH corresponding to the terminal according to preset resources”:

the preset resources include at least one of follows:

Control Channel Elements (CCEs) occupied by PDCCH, the number of CCEs occupied by PDCCH, sub-frames occupied by PDCCH, the number of sub-frames occupied by PDCCH, sub-frames occupied by PUCCH, the number of sub-frames occupied by PUCCH, sub-frames occupied by PDSCH, the number of sub-frames occupied by PDSCH, Physical Resource Blocks (PRBs) occupied by PDSCH, the number of PRBs occupied by PDSCH and an identification of the terminal.

Therein, the step of determining a PUCCH corresponding to the terminal according to preset resources includes:

acquiring a reference PUCCH;

determining a PUCCH offset according to the acquired reference PUCCH and the preset resources; and determining the PUCCH by using formula (5):

n=N_{ref}+N_{Offset} (5)

In formula (5), n denotes the index of PUCCH, N_{ref} denotes the index of reference PUCCH and N_{Offset} denotes the PUCCH offset.

Therein, acquiring a reference PUCCH includes:

when the PUCCH is the PUCCH format 1/1a/1b, acquiring the reference PUCCH as a PUCCH format 1/1a/1b channel indexed as 0; or a PUCCH format 1/1a/1b channel indexed as N_{PUCCH}⁽¹⁾−1; or a PUCCH format 1/1a/1b channel indexed as Q⁽¹⁾; and when the PUCCH is the PUCCH format 2/2a/2b, acquiring the reference PUCCH as a PUCCH format 2/2a/2b channel indexed as 0; or a PUCCH format 2/2a/2b channel indexed as N_{PUCCH,max}⁽²⁾−1; or a PUCCH format 2/2a/2b channel indexed as N_{PUCCH,max}⁽²⁾−Q⁽²⁾−1.

Therein, the step of determining the PUCCH offset according to the acquired reference PUCCH and the preset resources includes: determining a direction of the PUCCH offset according to the acquired reference PUCCH; and determining a magnitude of the PUCCH offset according to the preset resources. Therein, the step of determining a direction of the PUCCH offset according to the acquired reference PUCCH includes:

when the acquired reference PUCCH is a PUCCH format 1/1a/1b channel indexed as 0, or a PUCCH format 2/2a/2b channel indexed as 0 or a PUCCH format 1/1a/1b channel indexed as Q⁽¹⁾, determining the direction of the PUCCH offset to be positive; and when the acquired reference PUCCH is a PUCCH format 1/1a/1b channel indexed as N_{PUCCH}⁽¹⁾−1, or a PUCCH format 2/2a/2b channel indexed as N_{PUCCH,max}⁽²⁾−1 or a PUCCH format 2/2a/2b channel indexed as N_{PUCCH,max}⁽²⁾−Q⁽²⁾−1, determining the direction of the PUCCH offset to be negative.

The step of determining a magnitude of the PUCCH offset according to the preset resources includes:

determining the magnitude of the PUCCH offset according to an index of the first sub-frame occupied by the PDCCH; or according to an index of the first CCE occupied by the PDCCH and the number of the CCEs; or according to the number of the sub-frames occupied by the PDCCH; or according to the index of the first CCE occupied by the PDCCH, the index of the first sub-frame, the number of the CCEs and the number of the sub-frames; or according to the number of the sub-frames occupied by the PUCCH; or according to the number of the sub-frames occupied by the PDSCH; or according to the identification of the terminal.

Since the N_{PUCCH}⁽¹⁾ PUCCH format 1/1a/1b channels indexed from 0 to N_{PUCCH}⁽¹⁾−1 are not used for an implicit PUCCH mapping process related to HARQ-ACK feedback of the normal LTE terminal, i.e., it is not related to indexes of CCEs occupied by the PDCCH of the normal LTE terminal, and the PUCCH format 2/2a/2b channels of the existing LTE system are not used for transmitting the HARQ-ACK feedback information, the embodiment of the present document directly selects one PUCCH from the N_{PUCCH}⁽¹⁾ PUCCH format 1/1a/1b channels or N_{PUCCH,max}⁽²⁾ PUCCH format 2/2a/2b channels according to the preset resources as a PUCCH for transmitting HARQ-ACK feedback of the coverage-enhanced terminal, and thus the conflict between the HARQ-ACK feedback channels of the coverage-enhanced terminal and the normal LTE terminal is avoided.

In this step, when the transmission policy is determining the preset terminal-specific PUCCH to be the PUCCH corresponding to the terminal, it includes:

a PUCCH format 1/1a/1b channel indexed as 0;

or a PUCCH format 1/1a/1b channel indexed as N_{PUCCH}⁽¹⁾−1; or a PUCCH format 1/1a/1b channel indexed as Q⁽¹⁾; or a PUCCH format 2/2a/2b channel indexed as 0; or a PUCCH format 2/2a/2b channel indexed as N_{PUCCH,max}⁽²⁾−1; or a PUCCH format 2/2a/2b channel indexed as N_{PUCCH,max}⁽²⁾−Q⁽²⁾−1.

Since the N_{PUCCH}⁽¹⁾ PUCCH format 1/1a/1b channels indexed from 0 to N_{PUCCH}⁽¹⁾−1 are not used for an implicit PUCCH mapping process related to HARQ-ACK feedback of the normal LTE terminal, i.e., it is not related to indexes of CCEs occupied by the PDCCH of the normal LTE terminal, and the PUCCH format 2/2a/2b channels of the existing LTE system are not used for transmitting the HARQ-ACK feedback information, the embodiment of the present document directly selects one fixed PUCCH from the N_{PUCCH}⁽¹⁾ PUCCH format 1/1a/1b channels or N_{PUCCH,max}⁽²⁾ PUCCH format 2/2a/2b channels as a specific PUCCH for transmitting HARQ-ACK feedback of all coverage-enhanced terminals, and thus the conflict between the HARQ-ACK feedback channels of the coverage-enhanced terminal and the normal LTE terminal is avoided. In needs to be stated that each uplink sub-frame at this moment only supports the HARQ-ACK feedback of at most one coverage-enhanced terminal.

In Step 601, the terminal transmits HARQ-ACK feedback information through the determined PUCCH, and the base station receives the HARQ-ACK feedback information from the terminal through the PUCCH corresponding to the terminal.

In this step, when the PUCCH is the PUCCH format 2/2a/2b channel, the terminal transmits the HARQ-ACK feedback information in the form of PUCCH format 2 through the determined PUCCH format 2/2a/2b channel, and the base station receives the HARQ-ACK feedback information from the terminal in the form of PUCCH format 2 through the PUCCH format 2/2a/2b channel corresponding to the terminal.

In the method provided by the embodiment of the present document, by configuring the proprietary PUCCHs or candidate PUCCHs for transmitting the HARQ-ACK feedback for the terminal in the coverage-enhanced mode or scenario, the conflict between the HARQ-ACK feedback channels of the coverage-enhanced terminal and the normal LTE terminal is avoided.

The method provided by the embodiment of the present document further includes that:

when the HARQ-ACK feedback information and service data are transmitted on the same sub-frame,

the terminal cancels the transmission of the service data, and transmits the HARQ-ACK feedback information through the PUCCH determined according to the method of the embodiment of the present document or PUSCH resources bearing the service data; and correspondingly, the base station receives the HARQ-ACK feedback information through the PUCCH determined according to the method of the embodiment of the preset invention or PUSCH resources bearing the service data.

Therein, transmitting the HARQ-ACK feedback information through the PUSCH resources bearing the service data includes: transmitting the HARQ-ACK feedback information according to the way of transmitting service data through the PUSCH; or selecting a PRB pair from resources corresponding to the PUSCH bearing the service data, and transmitting the HARQ-ACK feedback information by means of a PUCCH format 1a/1b. Through the way of canceling the transmission of the service data in the present document, the coverage performance of the HARQ-ACK feedback is guaranteed.

More preferably, when the HARQ-ACK feedback information and the service data are transmitted on the same sub-frame, the terminal transmits the service data according to the number of sub-frames after addition; or after the service data are transmitted, adaptively repetitively transmits the service data; or according to the number of sub-frames for simultaneously transmitting the HARQ-ACK feedback information and the service data, determines whether to adaptively repetitively transmit the service data after the service data are transmitted. Correspondingly, the base station receives the service data according to the number of sub-frames after addition; or after the service data are transmitted, receives the service data according to a way of adaptively repetitively transmitting; or according to the number of sub-frames for simultaneously transmitting the HARQ-ACK feedback information and the service data, determines whether to receive the service data according to the way of adaptively repetitively transmitting after the service data are transmitted.

Through the above-mentioned method, the coverage performance of the HARQ-ACK feedback is guaranteed and simultaneously the coverage performance of the service data is also guaranteed.

In the method provided by the embodiment of the present document, by canceling the transmission of the service data when the HARQ-ACK feedback information and the service data are transmitted on the same sub-frame, the coverage performance of the HARQ-ACK feedback is guaranteed.

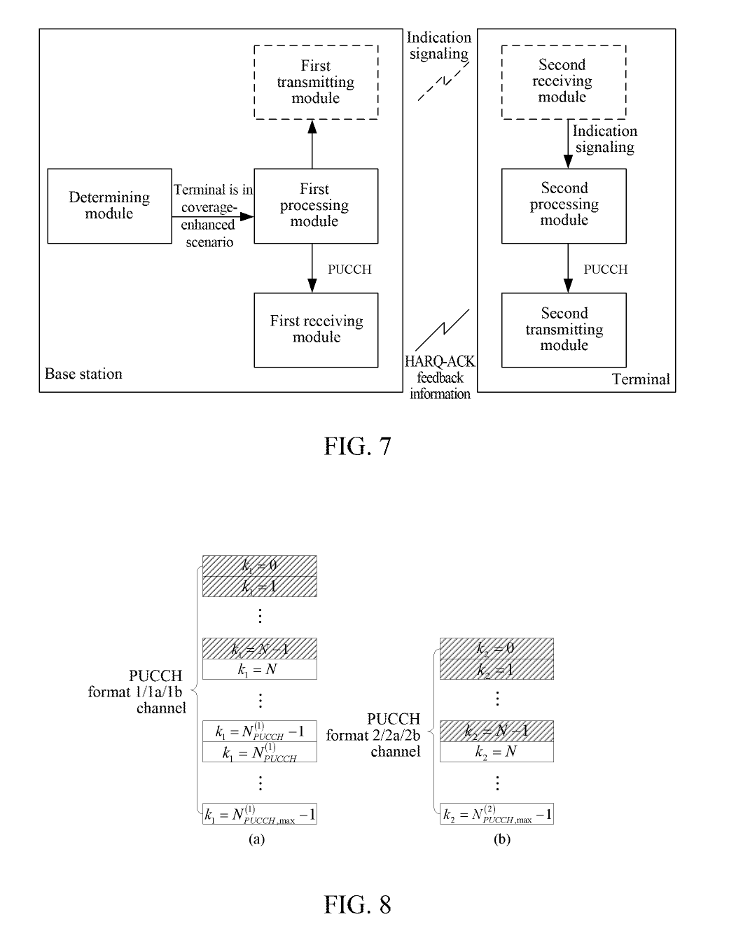

FIG. 7 is a schematic diagram of a component structure of a transmission system for HARQ-ACK feedback information provided by the embodiment of the present document. As shown in FIG. 7, the transmission system at least includes a base station and a terminal, wherein,

the base station is configured to, when determining that the terminal is in a coverage-enhanced scenario, determine a PUCCH corresponding to the terminal according to a preset transmission policy; and receive HARQ-ACK feedback information through the PUCCH corresponding to the terminal; and

the terminal is configured to determine a PUCCH corresponding to the terminal according to a preset transmission policy; and transmit HARQ-ACK feedback information through the determined PUCCH;

herein the transmission policy can be:

the base station transmits PUCCH indication signaling to the terminal, the indication signaling carries information of one PUCCH of preset N PUCCHs, the one PUCCH is a PUCCH corresponding to the terminal, herein N is a positive integer greater than or equal to 2;

or determines a PUCCH corresponding to the terminal according to preset resources;

or determines a preset terminal-specific PUCCH to be a PUCCH corresponding to the terminal.

The base station in the system provided by the embodiment of the present document at least includes a determining module, a first processing module and a first receiving module, herein,

the determining module is configured to, when determining that the terminal is in a coverage-enhanced scenario, notify the first processing module;

the first processing module is provided with the transmission policy and is configured to determine the PUCCH corresponding to the terminal according to the transmission policy; and

the first receiving module is configured to receive the HARQ-ACK feedback information from the terminal through the PUCCH corresponding to the terminal; and

the terminal at least includes a second processing module and a second transmitting module, herein,

the second processing module is provided with the transmission policy and is configured to determine the PUCCH corresponding to the terminal according to the transmission policy; and

the second transmitting module is configured to transmit the HARQ-ACK feedback information through the determined PUCCH.

Therein, the base station further includes a first transmitting module configured to receive a notification from the first processing module and transmit PUCCH indication information to the terminal; and correspondingly,

the terminal further includes a second receiving module configured to receive the indication signaling from the base station and output the indication signaling to the second processing module.

Therein, the PUCCH can be a PUCCH format 1/1a/1b channel or a PUCCH format 2/2a/2b channel.

The embodiment of the present document further provides a computer program, comprising program instructions, herein when the program instructions are executed by a base station, the base station is enabled to execute the above mentioned method.

The embodiment of the present document further provides a computer program, comprising program instructions, herein when the program instructions are executed by a terminal, the terminal is enabled to execute the above mentioned method.

The embodiment of the present document further provides a carrier carrying any one of the computer programs.

The method of the present document will be described below in detail in combination with the specific embodiments.

FIG. 8 is a schematic diagram of positions of preset N PUCCHs in embodiment 1 of the present document. As shown in FIG. 8, in embodiment 1, it is supposed that the preset N PUCCHs are continuous, herein N is a positive integer greater than or equal to 2.

In FIG. 8(a), it is supposed that the PUCCHs are PUCCH format 1/1a/1b channels, herein an index of the first PUCCH is 0 and indexes of other (N−1) PUCCHs are respectively 1 to (N−1), as shown by oblique line shadows in FIG. 8(a); and in FIG. 8(b), it is supposed that the PUCCHs are PUCCH format 2/2a/2b channels, herein an index of the first PUCCH is 0 and indexes of other (N−1) PUCCHs are respectively 1 to (N−1), as shown by oblique line shadows in FIG. 8(b). It needs to be stated that the first PUCCH of the N continuous PUCCHs is not limited to the PUCCH format 1/1a/1b channel or PUCCH format 2/2a/2b channel indexed as 0. For example, the first PUCCH of the N continuous PUCCHs can also be a PUCCH format 1/1a/1b channel indexed as N_{PUCCH}⁽¹⁾−1, correspondingly indexes of other (N−1) PUCCHs are respectively N_{PUCCH}⁽¹⁾−2 to N_{PUCCH}⁽¹⁾−N; or the first PUCCH of the N continuous PUCCHs can also be a PUCCH format 1/1a/1b channel indexed as Q⁽¹⁾, correspondingly indexes of other (N−1) PUCCHs are respectively Q⁽¹⁾+1 to Q⁽¹⁾+N−1; or the first PUCCH of the N continuous PUCCHs can also be a PUCCH format 2/2a/2b channel indexed as N_{PUCCH,max}⁽²⁾−1, correspondingly indexes of other (N−1) PUCCHs are respectively N_{PUCCH,max}⁽²⁾−2 to N_{PUCCH,max}⁽²⁾−N; or the first PUCCH of the N continuous PUCCHs can also be a PUCCH format 2/2a/2b channel indexed as N_{PUCCH,max}⁽²⁾−Q⁽²⁾−1, correspondingly indexes of other (N−1) PUCCHs are respectively N_{PUCCN,max}⁽²⁾−Q⁽²⁾−2 to N_{PUCCH,max}⁽²⁾−Q⁽²⁾−N.

According to the signaling from the base station, the terminal determines that which one of the preset N PUCCHs is to be used to transmit the HARQ-ACK feedback information.

Through the preset N PUCCHs, the base station and the terminal can simply acquire the transmission parameters and indexes of the preset N PUCCHs, such that the implementation is simplified and the satisfaction of the low cost demand of the coverage-enhanced terminal is facilitated.

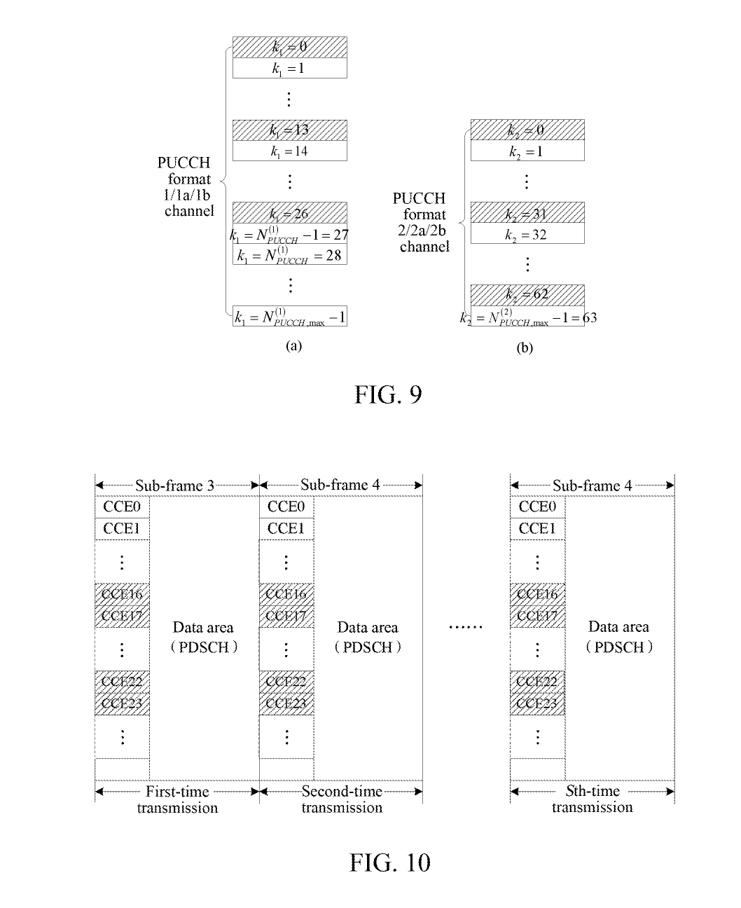

FIG. 9 is a schematic diagram of positions of preset N PUCCHs in embodiment 2 of the present document. As shown in FIG. 9, in embodiment 2, it is supposed that the preset N PUCCHs are discontinuous, herein N is a positive integer greater than or equal to 2.

In FIG. 9(a), it is supposed that the PUCCHs are PUCCH format 1/1a/1b channels, N is equal to 3 and N_{PUCCH}⁽¹⁾ is equal to 28, then an index of the first PUCCH of 3 (N=3) PUCCHs is 0 and indexes of other two PUCCHs are respectively 13 and 26, as shown by oblique line shadows in FIG. 9(a); a spacing between two adjacent channels is 13, i.e., the following condition is satisfied:

$$I = ceiling ( \frac{{N}_{PUCCH}^{( 1 )}}{N - 1} ) - 1 = ceiling ( \frac{28}{3 - 1} ) - 1 = 13 , \qquad$$

herein I denotes a spacing between two adjacent PUCCHs and ceiling denotes an operation of rounding up to integer.

Specifically, in FIG. 9(b), it is supposed that the PUCCHs are PUCCH format 2/2a/2b channels, N is equal to 3 and N_{PUCCH,max}⁽²⁾ is equal to 64, as shown in oblique line shadows in FIG. 9(b), then an index of the first PUCCH of 3 (N=3) PUCCHs is 0, and indexes of other two PUCCHs are respectively 31 and 62; and a spacing between two adjacent channels is 31, i.e., the following condition is satisfied:

$$I = ceiling ( \frac{{N}_{PUCCH , max}^{( 2 )}}{N - 1} ) - 1 = ceiling ( \frac{64}{3 - 1} ) - 1 = 31 , \qquad$$

herein I denotes a spacing between two adjacent PUCCHs and ceiling denotes an operation of rounding up to integer.

It needs to be stated, in this embodiment, the first PUCCH of the N discontinuous PUCCHs is not limited to the PUCCH format 1/1a/1b channel or PUCCH format 2/2a/2b channel indexed as 0. For example, the first PUCCH of the N discontinuous PUCCHs can also be a PUCCH format 1/1a/1b channel indexed as N_{PUCCH}⁽¹⁾−1, indexes of other (N−1) PUCCHs are less than N_{PUCCH}⁽¹⁾−1 and a spacing between two adjacent channels is determined through formula (1); or the first PUCCH of the N discontinuous PUCCHs can also be a PUCCH format 1/1a/1b channel indexed as Q⁽¹⁾, indexes of other (N−1) PUCCHs are greater than Q⁽¹⁾ and a spacing between two adjacent channels is determined through formula (2); or the first PUCCH of the N discontinuous PUCCHs can also be a PUCCH format 2/2a/2b channel indexed as N_{PUCCH,max}⁽²⁾−1, indexes of other (N−1) PUCCHs are less than N_{PUCCH,max}⁽²⁾−1 and a spacing between two adjacent channels is determined through formula (3); or the first PUCCH of the N discontinuous PUCCHs can also be a PUCCH format 2/2a/2b channel indexed as N_{PUCCH,max}⁽²⁾−Q⁽²⁾−1, indexes of other (N−1) PUCCHs are less than N_{PUCCH,max}⁽²⁾−Q⁽²⁾−1 and a spacing between two adjacent channels is determined through formula (4).

According to the signaling from the base station, the terminal determines that which one of the preset N PUCCHs is to be used to transmit the HARQ-ACK feedback information.

Through the preset N discontinuous PUCCHs which are uniformly distributed, the situation that different channels of the preset N PUCCHs multiplex on the same PUCCH resources by means of code division is avoided, thus the mutual interference between the HARQ-ACK feedbacks of different coverage-enhanced terminals is reduced and the coverage performance of the HARQ-ACK feedback is improved.

In the existing LTE system, since the N_{PUCCH}⁽¹⁾ PUCCH format 1/1a/1b channels indexed from 0 to N_{PUCCH}⁽¹⁾−1 are not used for an implicit PUCCH mapping process related to HARQ-ACK feedback of the normal LTE terminal, it is not related to indexes of CCEs occupied by the PDCCH of the normal LTE terminal and the PUCCH format 2/2a/2b channels are not used for transmitting the HARQ-ACK feedback information, the embodiment of the present document selects the preset N PUCCHs from the N_{PUCCH}⁽¹⁾ PUCCH format 1/1a/1b channels or the N_{PUCCH,max}⁽²⁾ PUCCH format 2/2a/2b channels as candidate PUCCHs for transmitting the HARQ-ACK feedback of the coverage-enhanced terminal, and thus the conflict between the HARQ-ACK feedback channels of the coverage-enhanced terminal and the normal LTE terminal is avoided.

FIG. 10 is a schematic diagram of sub-frames and CCEs occupied by a PDCCH in the embodiment of the present document. As shown in FIG. 10, specifically, at a determined coverage level, to view from a sub-frame dimension, the PDCCH occupies totally S continuous sub-frames and an index of the first sub-frame is 3, or downlink allocation is repetitively transmitted for S times through the PDCCH; to view from a CCE dimension, the PDCCH occupies totally eight continuous CCEs and an index of the first CCE is 16, as shown by oblique line shadows in FIG. 10. It needs to be stated that, since a wireless frame of the existing LTE system includes 10 sub-frames, the indexes of the sub-frames range from 0 to 9.

Embodiment 3: it is supposed that the PUCCH for transmitting the HARQ-ACK feedback is a format 1/1a/1b channel and the reference PUCCH is a format 1/1a/1b channel indexed as 0. Thus,

firstly, a direction of a PUCCH offset is determined to be positive “+”;

then, according to the index of the first sub-frame occupied by the PDCCH, a magnitude of the PUCCH offset is determined to be |N_{Offset}|, herein |·| denotes an operation of taking absolute value or magnitude. For example, the magnitude of the PUCCH can be determined through formula (6):

|N_{Offset}|=mod (C₁·s_{f},N_{PUCCH}⁽¹⁾) (6),

in formula (6), S_{f} denotes an index of the first sub-frame occupied by PDCCH, C₁ denotes a determined constant factor and mod denotes an operation of taking remainder;

finally, the PUCCH is determined through formula (5).

In embodiment 3, N_{ref}=0, N_{Offset}=|N_{Offset}|.

Both the terminal and the base station transmit the HARQ-ACK feedback information through the PUCCH format 1/1a/1b channel indexed as |N_{Offset}|(n=0+1N_{Offset}|).

Embodiment 4: it is supposed that the PUCCH for transmitting the HARQ-ACK feedback is a format 1/1a/1b channel and the reference PUCCH is a format 1/1a/1b channel indexed as N_{PUCCH}⁽¹⁾−1. Thus, firstly, a direction of a PUCCH offset is determined to be negative “−”; then, according to the index of the first sub-frame occupied by the PDCCH, a magnitude of the PUCCH offset is determined to be |N_{Offset}|, herein |·| denotes an operation of taking absolute value or magnitude. For example, the magnitude of the PUCCH can be determined through formula (6);

finally, the PUCCH is determined through formula (5).

In embodiment 4,

N_{ref}=N_{PUCCH}⁽¹⁾−1,N_{Offset}=−|N_{Offset}|.

Both the terminal and the base station transmit the HARQ-ACK feedback information through the PUCCH format 1/1 a/1b channel indexed as N_{PUCCH}⁽¹⁾−1−|N_{Offset}| (i.e., n=N_{PUCCH}⁽¹⁾−1−|N_{Offset}|).

Embodiment 5: it is supposed that the PUCCH for transmitting the HARQ-ACK feedback is a format 1/1a/1b channel and the reference PUCCH is a format 1/1a/1b channel indexed as Q⁽¹⁾. Thus, firstly, a direction of a PUCCH offset is determined to be positive “+”;

then, according to the index of the first sub-frame occupied by the PDCCH, a magnitude of the PUCCH offset is determined to be |N_{Offset}|, herein |·| denotes an operation of taking absolute value or magnitude. For example, the magnitude of the PUCCH can be determined through formula (7):

|N_{Offset}|=mod (C₁·s_{f},N_{PUCCH}⁽¹⁾−Q⁽¹⁾) (7),

in formula (7), S (denotes an index of the first sub-frame occupied by PDCCH, C₁ denotes a determined constant factor and mod denotes an operation of taking remainder;

finally, the PUCCH is determined through formula (5).

In embodiment 3,

N_{ref}=Q⁽¹⁾,N_{Offset}=|N_{Offset}|.

Both the terminal and the base station transmit the HARQ-ACK feedback information through the PUCCH format 1/1a/1b channel indexed as Q⁽¹⁾+|N_{Offset}|(n=Q⁽¹⁾+|N_{Offset}|).

Embodiment 6: it is supposed that the PUCCH for transmitting the HARQ-ACK feedback is a format 2/2a/2b channel and the reference PUCCH is a format 2/2a/2b channel indexed as 0. Thus,

firstly, a direction of a PUCCH offset is determined to be positive “+”;

then, according to the index of the first sub-frame occupied by the PDCCH, a magnitude of the PUCCH offset is determined to be |N_{offset}|, herein |·| denotes an operation of taking absolute value or magnitude. For example, the magnitude of the PUCCH can be determined through formula (8):

|N_{Offset}|=mod (C₁·s_{f},N_{PUCCH,max}⁽²⁾) (8),

in formula (8), S_{f} denotes an index of first sub-frame occupied by PDCCH, C₁ denotes a determined constant factor and mod denotes an operation of taking remainder;

finally, the PUCCH is determined through formula (5).

In embodiment 5,

N_{ref}=0,N_{Offset}=+|N_{Offset}|.

Both the terminal and the base station transmit the HARQ-ACK feedback information through the PUCCH format 2/2a/2b channel indexed as |N_{Offset}| (i.e., n=0+|N_{Offset}|).

Embodiment 7: it is supposed that the PUCCH for transmitting the HARQ-ACK feedback is a format 2/2a/2b channel and the reference PUCCH is a format 2/2a/2b channel indexed as N_{PUCCH,max}⁽²⁾−1. Thus,

firstly, a direction of a PUCCH offset is determined to be negative “−”;

then, according to the index of the first sub-frame occupied by the PDCCH, a magnitude of the PUCCH offset is determined to be |N_{Offset}|, herein |·| denotes an operation of taking absolute value or magnitude. For example, the magnitude of the PUCCH can be determined through formula (8);

finally, the PUCCH is determined through formula (5). In embodiment 6,

N_{ref}=N_{PUCCH,max}⁽²⁾−1,N_{Offset}=−|N_{Offset}|. (2)

Both the terminal and the base station transmit the HARQ-ACK feedback information through the PUCCH format 2/2a/2b channel indexed as N_{PUCCH,max}⁽²⁾−1−|N_{Offset}| (i.e., n=N_{PUCCH,max}⁽²⁾−1−|N_{Offset}|).

Embodiment 8: it is supposed that the PUCCH for transmitting the HARQ-ACK feedback is a format 2/2a/2b channel and the reference PUCCH is a format 2/2a/2b channel indexed as N_{PUCCH,max}⁽²⁾−Q⁽²⁾−1. Thus,

firstly, a direction of a PUCCH offset is determined to be negative “−”;

then, according to the index of the first sub-frame occupied by the PDCCH, a magnitude of the PUCCH offset is determined to be |N_{Offset}|, herein |·| denotes an operation of taking absolute value or magnitude. For example, the magnitude of the PUCCH can be determined through formula (9):)

|N_{Offset}|=mod (C₁·s_{f},N_{PUCCH,max}⁽²⁾−Q⁽²⁾) (9)

in formula (9), S_{f} denotes an index of first sub-frame occupied by PDCCH, C₁ denotes a determined constant factor and mod denotes an operation of taking remainder;

finally, the PUCCH is determined through formula (5).

In embodiment 5,

N_{ref}=N_{PUCCH,max}⁽²⁾−Q⁽²⁾−1,N_{Offset}=−|N_{Offset}|.

Both the terminal and the base station transmit the HARQ-ACK feedback information through the PUCCH format 2/2a/2b channel indexed as N_{PUCCH,max}⁽²⁾−Q⁽²⁾−1−|N_{Offset}| (i.e., n=N_{PUCCH,max}⁽²⁾−Q⁽²⁾−1−|N_{Offset}|).

It needs to be stated that, for embodiments 3-8, in the step of determining the magnitude |N_{Offset}| of the PUCCH offset according to the index of the first sub-frame occupied by the PDCCH, the magnitude |N_{Offset}| of the PUCCH offset can also be determined according to at least one of other preset resources in addition to the index of the first sub-frame occupied by the PDCCH. Specifically,

for example, the magnitude |N_{Offset}| of the PUCCH offset is determined according to an index of the first CCE occupied by the PDCCH and the number of CCEs and formula (10):

$$\vert {N}_{Offset} \vert = mod ( {C}_{2} \cdot \frac{{p}_{f}}{P} , Z ) , \qquad ( 10 )$$

in formula (10), p_{f} and P respectively denote an index of first CCE occupied by PDCCH and the number of CCEs, C₂ denotes a determined constant factor and mod denotes an operation of taking remainder;

for another example, the magnitude |N_{Offset}| of the PUCCH offset is determined according to the number of sub-frames occupied by the PDCCH, the number of sub-frames occupied by the PUCCH or the number of sub-frames occupied by the PDSCH and formula (11):

$$\vert {N}_{Offset} \vert = mod ( {C}_{3} \cdot \frac{S}{{C}_{4}} , Z ) , \qquad ( 11 )$$

in formula (11), S denotes the number of sub-frames occupied by PDCCH, the number of sub-frames occupied by PUCCH or the number of sub-frames occupied by PDSCH, C₃ and C₄ denote determined constant factors and mod denotes an operation of taking remainder;

for another example, the magnitude |N_{Offset}| of the PUCCH offset is determined according to an index of the first CCE occupied by the PDCCH and the number of CCEs, an index of the first sub-frame and the number of sub-frames, and formula (12):

$$\begin{matrix}\vert {N}_{Offset} \vert = mod ( mod ( {C}_{1} \cdot {s}_{f} , Z ) + mod ( {C}_{2} \cdot \frac{{p}_{f}}{P} , Z ) + mod ( {C}_{3} \cdot \frac{S}{{C}_{4}} , Z ) , Z ) , & \end{matrix} \qquad ( 12 )$$

in formula (12), S_{f} denotes an index of the first sub-frame occupied by PDCCH, p_{f} and P respectively denote an index of the first CCE occupied by PDCCH and the number of CCEs, S denotes the number of sub-frames occupied by PDCCH, the number of sub-frames occupied by PUCCH or the number of sub-frames occupied by PDSCH, C₁, C₂, C₃ and C₄ denote determined constant factors and mod denotes an operation of taking remainder;

for another example, the magnitude |N_{Offset}| of the PUCCH offset is determined according to an identification of the terminal and formula (13):

|N_{Offset}|=mod(id,Z) (13),

in formula (13), id denotes an identification of the terminal and mod denotes an operation of taking remainder.

In formulas (10)-(13),

if the reference PUCCH is a PUCCH format 1/1a/1b channel indexed as 0 or N_{PUCCH}⁽¹⁾−1, Z is equal to N_{PUCCH}⁽¹⁾; if the reference PUCCH is a PUCCH format 1/1a/1b channel indexed as Q⁽¹⁾, Z is equal to N_{PUCCH}⁽¹⁾−Q⁽¹⁾−1; if the reference PUCCH is a PUCCH format 2/2a/2b channel indexed as 0 or N_{PUCCH,max}⁽²⁾−1, Z is equal to N_{PUCCH,max}⁽²⁾; and if the reference PUCCH is a PUCCH format 2/2a/2b channel indexed as N_{PUCCH,max}⁽²⁾−Q⁽²⁾−1, Z is equal to N_{PUCCH,max}⁽²⁾−Q⁽²⁾.

Through the above-mentioned method, the control overhead used for notifying the coverage-enhanced terminal about the PUCCH for transmitting the HARQ-ACK feedback is reduced, and the coverage enhancement of the control channel and the improvement of system spectrum efficiency are facilitated.

In the existing LTE system, since the N_{PUCCH}⁽¹⁾ PUCCH format 1/1a/1b channels indexed from 0 to N_{PUCCH}⁽¹⁾−1 are not used for an implicit PUCCH mapping process related to HARQ-ACK feedback of the normal LTE terminal, it is not related to indexes of CCEs occupied by the PDCCH of the normal LTE terminal, and the PUCCH format 2/2a/2b channels are not used for transmitting the HARQ-ACK feedback information, the embodiment of the present document directly selects one PUCCH from the N_{PUCCH}⁽¹⁾ PUCCH format 1/1a/1b channels or from N_{PUCCH,max}⁽²⁾ PUCCH format 2/2a/2b channels according to the preset resources as a PUCCH for transmitting the HARQ-ACK feedback of the coverage-enhanced terminal, and thus the conflict between the HARQ-ACK feedback channels of the coverage-enhanced terminal and the normal LTE terminal is avoided.

### Embodiment 9

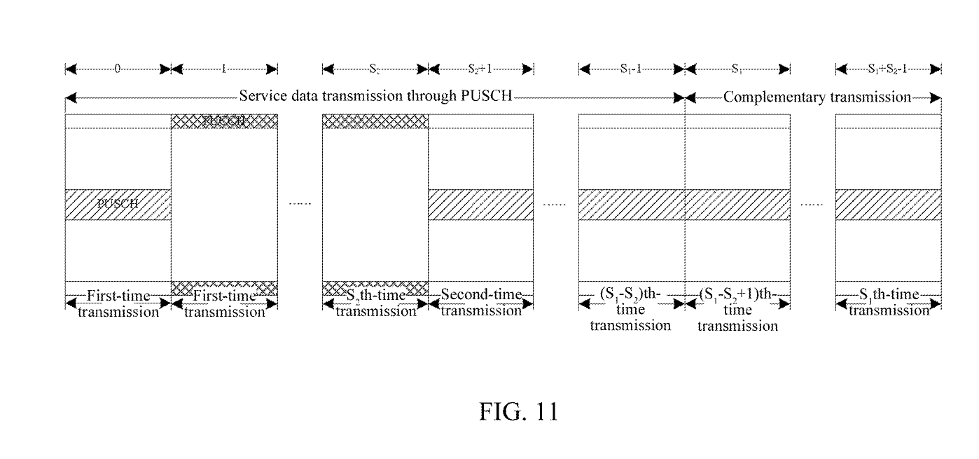

FIG. 11 is a schematic diagram of transmission of HARQ-ACK feedback information through uplink sub-frames with service data transmission in embodiment 9 of the present document, herein oblique line shadow blocks denote PUSCHs and oblique square checker shadow blocks denote PUCCHs. Under this situation, the terminal cancels the transmission of the service data and transmits the HARQ-ACK feedback information through the determined PUCCH.

As shown in FIG. 11, it is supposed that the base station requires the terminal to transmit the service data through the PUSCH within S₁ sub-frames whose sequence numbers are from 0 to (S₁−1) as shown in FIG. 11, and simultaneously the terminal further needs to transmit the HARQ-ACK feedback information of downlink data within S₂ sub-frames whose sequence numbers are from 1 to S₂ of the S₁ sub-frames according to HARQ timing.

Therein, S₁ denotes the number of sub-frames occupied by the PUSCH for transmitting the service data at a determined coverage level, or times of repetitive transmission of the service data through the PUSCH; and S₂ denotes the number of sub-frames occupied by the PUCCH at a determined coverage level or times of repetitive transmission of HARQ-ACK feedback through the PUCCH, and S₂ is less than S₁.

As shown in FIG. 11, under this situation, within the range of the S₂ sub-frames whose sequence numbers are from 1 to S₂, the terminal cancels the transmission of the service data transmitted through the PUSCH and transmits the HARQ-ACK feedback information through the determined PUCCH.

Thus, within the range of S₁ sub-frames whose sequence numbers are from 0 to (S₁−1), due to the transmission of the HARQ-ACK feedback information, the service data which originally need to be transmitted for S₁ times through the PUSCH are actually transmitted only for (S₁−S₂) times. Therefore, within the range of sub-frames whose sequence numbers are from S₁ to (S₁+S₂−1), the terminal executes complementary service data transmission through the PUSCH, i.e., finally compensates the coverage loss of the service data by increasing the number of sub-frames for transmitting the service data.

In addition, the way for compensating the coverage loss of the service data is not limited to increasing the number of the sub-frames for transmitting the service data in embodiment 7, and can also be: adaptively repetitively transmitting the service data after the service data are transmitted; or determining whether to adaptively repetitively transmit the service data after the service data are transmitted according to the number of the sub-frames for simultaneously transmitting the HARQ-ACK feedback information and the service data. Therein, adaptively repetitively transmitting the service data after the service data are transmitted refers to that, without the uplink grant from the base station, the terminal will continuously occupy the subsequent determined sub-frames after one transmission of the service data is completed and adaptively repetitively transmit the service data through the PUSCH. It needs to be stated that the time interval between the first sub-frame of the repetitively transmitted sub-frames and the last sub-frame of the previously transmitted sub-frames can be preset.

Determining whether to adaptively repetitively transmit the service data after the service data are transmitted according to the number of the sub-frames for simultaneously transmitting the HARQ-ACK feedback information and the service data refers to that, for one transmission of the service data, if the number of the sub-frames for simultaneously transmitting the HARQ-ACK feedback information and the service data does not exceed a determined constant L, the terminal will not adaptively repetitively transmit the service data after the service data are transmitted; and otherwise, the terminal will adaptively repetitively transmit the service data after the service data are transmitted, herein L is a positive integer greater than 1.

### Embodiment 10

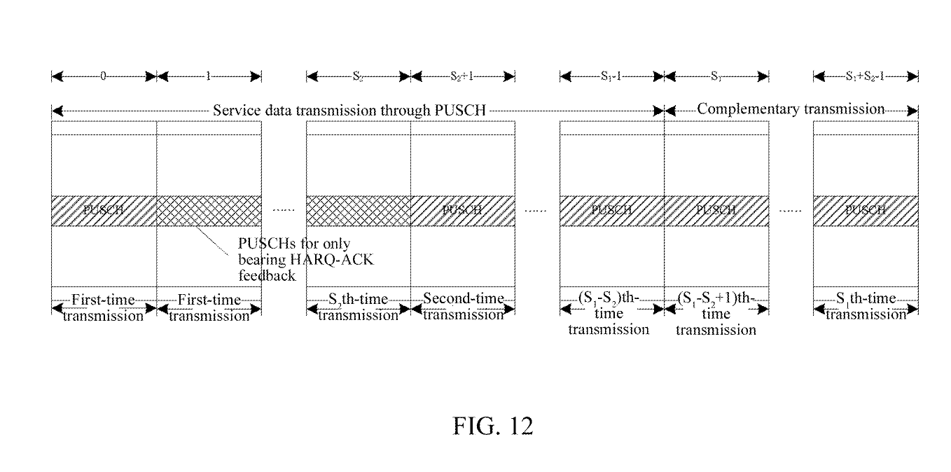

FIG. 12 is a schematic diagram of transmission of HARQ-ACK feedback information through uplink sub-frames with service data transmission in embodiment 10 of the present document, herein oblique line shadow blocks denote PUSCHs and oblique square checker shadow blocks denote PUSCHs for only bearing HARQ-ACK feedback, different from that in embodiment 9, under this situation, the terminal cancels the transmission of the service data and transmits the HARQ-ACK feedback information through the PUSCH resources bearing the service data.

As shown in FIG. 12, it is supposed that the base station requires the terminal to transmit the service data through the PUSCH within S₁ sub-frames whose sequence numbers are from 0 to (S₁−1) as shown in FIG. 12, and simultaneously the terminal further needs to transmit the HARQ-ACK feedback information of downlink data within S₂ sub-frames whose sequence numbers are from 1 to S₂ of the S₁ sub-frames according to HARQ timing.

Therein, S₁ denotes the number of sub-frames occupied by the PUSCH for transmitting the service data at a determined coverage level, or times of repetitive transmission of the service data through the PUSCH; and S₂ denotes the number of sub-frames occupied by the PUSCH at a determined coverage level or times of repetitive transmission of HARQ-ACK feedback through the PUSCH, and S₂ is less than S₁.

As shown in FIG. 12, under this situation, within the range of the S₂ sub-frames whose sequence numbers are from 1 to S₂, the terminal cancels the transmission of the service data transmitted through the PUSCH and transmits the HARQ-ACK feedback information through granted PUSCH channel resources.

Thus, within the range of S₁ sub-frames whose sequence numbers are from 0 to (S₁−1), due to the transmission of the HARQ-ACK feedback information, the service data which originally need to be transmitted for S₁ times through the PUSCH are actually transmitted only for (S₁−S₂) times. Therefore, within the range of sub-frames whose sequence numbers are from S₁ to (S₁+S₂−1), the terminal executes complementary service data transmission through the PUSCH, i.e., finally compensates the coverage loss of the service data by increasing the number of sub-frames for transmitting the service data.

In addition, the way for compensating the coverage loss of the service data is not limited to increasing the number of the sub-frames for transmitting the service data in embodiment 10, and can also be: adaptively repetitively transmitting the service data after the service data are transmitted; or determining whether to adaptively repetitively transmit the service data after the service data are transmitted according to the number of the sub-frames for simultaneously transmitting the HARQ-ACK feedback information and the service data. Therein, adaptively repetitively transmitting the service data after the service data are transmitted refers to that, without the uplink grant from the base station, the terminal will continuously occupy the subsequent determined sub-frames after one transmission of the service data is completed and adaptively repetitively transmit the service data through the PUSCH. It needs to be stated that the time interval between the first sub-frame of the repetitively transmitted sub-frames and the last sub-frame of the previously transmitted sub-frames can be preset.

Determining whether to adaptively repetitively transmit the service data after the service data are transmitted according to the number of the sub-frames for simultaneously transmitting the HARQ-ACK feedback information and the service data refers to that, for one transmission of the service data, if the number of the sub-frames for simultaneously transmitting the HARQ-ACK feedback information and the service data does not exceed a determined constant L, the terminal will not adaptively repetitively transmit the service data after the service data are transmitted; and otherwise, the terminal will adaptively repetitively transmit the service data after the service data are transmitted, herein L is a positive integer greater than 1.

Therein, the way for transmitting the HARQ-ACK feedback through PUSCH resources includes: transmitting the HARQ-ACK feedback information according to the way of for transmitting the service data through the PUSCH; or selecting a PRB pair from resources corresponding to the PUSCH, and transmitting the HARQ-ACK feedback information by means of a PUCCH format 1a/1b. Therein, transmitting the HARQ-ACK feedback information according to the way of transmitting the service data through the PUSCH includes:

approach 1: when transmitted HARQ-ACK bits are 0, repetitively transmitting one of BPSK (Binary Phase Shift Keying) modulated symbols on all RE (Resource Elements) included in PUSCH resources; and otherwise, repetitively transmitting the other one of BPSK modulated symbols on all REs included in the PUSCH resources. Correspondingly, the base station can receive the HARQ-ACK feedback information according to a maximum likelihood detection algorithm.

approach 2: after sequentially performing repetitive coding and BPSK or QPSK (Quadrature Phase Shift Keying) modulation on bits of the HARQ-ACK feedback information, sequentially mapping all generated modulated symbols to all REs included in the PUSCH resources for transmission.

One skilled in the art can understand that all or partial steps in the above-mentioned methods can be completed by a program instructing relevant hardware, and the program can be stored in a computer readable storage medium such as a read only memory, a magnetic disk or a compact disk. Optionally, all or partial steps of the above-mentioned embodiments can also be implemented by using one or more integrated circuits. Correspondingly, each module/unit in the above-mentioned embodiments can be implemented by means of hardware, and can also be implemented by means of a software function module. The present document is not limited to combinations of hardware and software in any specific form.

The embodiments are just preferred embodiments of the present document and are not used for limiting the protection range of the present document. Any modification, equivalent replacement, improvement and the like made within the essence and principle of the present document shall also be included in the protection range of the present document

### INDUSTRIAL APPLICABILITY

By configuring the proprietary PUCCHs or candidate PUCCH resources for transmitting the HARQ-ACK feedback for the terminal in a coverage-enhanced mode or scenario, the embodiments of the present document avoid the conflict between the HARQ-ACK feedback channels of the coverage-enhanced terminal and the normal LTE terminal.

What is claimed is:

1. A transmission method for Hybrid Automatic Repeat Request Acknowledgement (HARQ-ACK) feedback information, comprising: when a base station determines that a terminal is in a coverage-enhanced scenario,
determining, by the base station, a Physical Uplink Control Channel (PUCCH) corresponding to the terminal according to a preset transmission policy, wherein the transmission policy is: transmitting, by the base station, PUCCH indication signaling to the terminal, the indication signaling carrying information of one PUCCH of preset N PUCCHs, the one PUCCH being a PUCCH corresponding to the terminal, wherein N is a positive integer greater than or equal to 2; or determining a PUCCH corresponding to the terminal according to preset resources; or determining a preset terminal-specific PUCCH to be a PUCCH corresponding to the terminal; and
receiving, by the base station, HARQ-ACK feedback information from the terminal through the PUCCH corresponding to the terminal.

2. (canceled)

3. The transmission method according to claim 1, wherein, the transmission policy is: transmitting, by the base station, PUCCH indication signaling to the terminal, when the indication signaling carries information of one PUCCH of preset N PUCCHs, the preset N PUCCHs being continuous or discontinuous,
and,
wherein, when the PUCCHs are discontinuous PUCCH format 1/1a/1b channels, a spacing between two adjacent PUCCHs of the preset N PUCCHs is determined according to at least one of the following parameters:
a number N of the preset PUCCHs, an implicit mapping offset N_{PUCCH}⁽¹⁾ and a number Q⁽¹⁾ of PUCCH format 1/1a/1b channels included in hybrid PUCCH resources indexed as N_{RB}⁽²⁾,
and,
wherein, when the PUCCHs are discontinuous PUCCH format 2/2a/2b channels, a spacing between two adjacent PUCCHs of the preset N PUCCHs is determined according to at least one of the following parameters:
a number N of the preset PUCCHs, a total number N_{PUCCH,max}⁽²⁾ of PUCCH format 2/2a/2b channels, and a number Q⁽²⁾ of PUCCH format 2/2a/2b channels included in hybrid PUCCH resources indexed as N_{RB}⁽²⁾.

4. The transmission method according to claim 3, wherein, when the PUCCH is the PUCCH format 1/1a/1b channel,
a first PUCCH of the preset N PUCCHs is a PUCCH format 1/1a/1b channel indexed as 0; or a PUCCH format 1/1a/1b channel indexed as N_{PUCCH}⁽¹⁾−1; or a PUCCH format 1/1a/1b channel indexed as Q⁽¹⁾, wherein Q⁽¹⁾ is a number of PUCCH format 1/1a/1b channels included in hybrid PUCCH resources indexed as N_{RB}⁽²⁾,
or,
wherein, when the PUCCH is the PUCCH format 2/2a/2b channel,
a first PUCCH of the preset N PUCCHs is a PUCCH format 2/2a/2b channel indexed as 0;
or a PUCCH format 2/2a/2b channel indexed as N_{PUCCH,max}⁽²⁾−1, wherein N_{PUCCH,max}⁽²⁾ is a total number of PUCCH format 2/2a/2b channels; or a PUCCH format 2/2a/2b channel indexed as N_{PUCCH,max}⁽²⁾−Q⁽²⁾−1, wherein Q⁽²⁾ is a number of PUCCH format 2/2a/2b channels included in hybrid PUCCH resources indexed as N_{RB}⁽²⁾.

5. (canceled)

6. (canceled)

7. (canceled)

8. The transmission method according to claim 3, wherein the indication signaling comprises:
Downlink Control Information (DCI) signaling born in a Physical Downlink Control Channel (PDCCH) or Radio Resource Control (RRC) signaling born in a Physical Downlink Shared Channel (PDSCH),
and,
wherein, the RRC signaling comprises signaling born in Msg2 or Msg4 related to a random access process; and
the RRC signaling is semi-static configuration signaling,
and,
wherein the DCI signaling comprises DCI signaling for indicating a PUCCH for transmitting HARQ-ACK feedback information or DCI signaling for resource allocation of PDSCHs;
a DCI format is a proprietary DCI format of the coverage-enhanced terminal; and
the DCI signaling is dynamic configuration signaling.

9. (canceled)

10. (canceled)

11. (canceled)

12. The transmission method according to claim 1, wherein the transmission policy is: determining a PUCCH corresponding to the terminal according to preset resources; and
the preset resources comprise at least one of follows:
Control Channel Elements (CCEs) occupied by PDCCH, a number of CCEs occupied by PDCCH, sub-frames occupied by PDCCH, a number of sub-frames occupied by PDCCH, sub-frames occupied by PUCCH, a number of sub-frames occupied by PUCCH, sub-frames occupied by PDSCH, a number of sub-frames occupied by PDSCH, Physical Resource Blocks (PRBs) occupied by PDSCH, a number of PRBs occupied by PDSCH and an identification of the terminal,
and,
wherein the step of determining a PUCCH corresponding to the terminal according to preset resources comprises:
acquiring a reference PUCCH;
determining a PUCCH offset according to the acquired reference PUCCH and the preset resources; and
calculating a sum of an index of the reference PUCCH and the PUCCH offset, wherein the sum value is a PUCCH index.

13. (canceled)

14. The transmission method according to claim 13, wherein, when the PUCCH is the PUCCH format 1/1a/1b, the reference PUCCH comprises:
a PUCCH format 1/1a/1b channel indexed as 0;
or a PUCCH format 1/1a/1b channel indexed as N_{PUCCH}⁽¹⁾−1; or a PUCCH format 1/1a/1b channel indexed as Q⁽¹⁾,
or,
wherein, when the PUCCH is the PUCCH format 2/2a/2b, the reference PUCCH comprises:
a PUCCH format 2/2a/2b channel indexed as 0;
or a PUCCH format 2/2a/2b channel indexed as N_{PUCCH,max}⁽²⁾−1; or a PUCCH format 2/2a/2b channel indexed as N_{PUCCH,max}⁽²⁾−Q⁽²⁾−1.

15. (canceled)

16. The transmission method according to claim 13, wherein the step of determining a PUCCH offset according to the acquired reference PUCCH and the preset resources comprises:
determining a direction of the PUCCH offset according to the acquired reference PUCCH; and
determining a magnitude of the PUCCH offset according to the preset resources.

17. The transmission method according to claim 16, wherein the step of determining a direction of the PUCCH offset according to the acquired reference PUCCH comprises:
when the acquired reference PUCCH is a PUCCH format 1/1a/1b channel indexed as 0, or a PUCCH format 2/2a/2b channel indexed as 0 or a PUCCH format 1/1a/1b channel indexed as Q⁽¹⁾, determining the direction of the PUCCH offset to be positive; and
when the acquired reference PUCCH is a PUCCH format 1/1a/1b channel indexed as N_{PUCCH}⁽¹⁾−1, or a PUCCH format 2/2a/2b channel indexed as N_{PUCCH,max}⁽²⁾−1 or a PUCCH format 2/2a/2b channel indexed as N_{PUCCH,max}⁽²⁾−Q⁽²⁾−1, determining the direction of the PUCCH offset to be negative,
or,
wherein the step of determining a magnitude of the PUCCH offset according to the preset resources comprises:
determining the magnitude of the PUCCH offset according to an index of a first sub-frame occupied by the PDCCH; or according to an index of a first CCE occupied by the PDCCH and the number of the CCEs; or according to the number of the sub-frames occupied by the PDCCH; or according to the index of the first CCE occupied by the PDCCH, the index of the first sub-frame, the number of the CCEs and the number of the sub-frames; or according to the number of the sub-frames occupied by the PUCCH; or according to the number of the sub-frames occupied by the PDSCH; or according to the identification of the terminal.

18. (canceled)

19. The transmission method according to claim 1, wherein the transmission policy is determining a preset terminal-specific PUCCH to be a PUCCH corresponding to the terminal, comprising:
a PUCCH format 1/1a/1b channel indexed as 0;
or a PUCCH format 1/1a/1b channel indexed as N_{PUCCH}⁽¹⁾−1; or a PUCCH format 1/1a/1b channel indexed as Q^{W}; or a PUCCH format 2/2a/2b channel indexed as 0; or a PUCCH format 2/2a/2b channel indexed as N_{PUCCH,max}⁽²⁾−1; or a PUCCH format 2/2a/2b channel indexed as N_{PUCCH,max}⁽²⁾−Q⁽²⁾−1.

20. The transmission method according to claim 1, wherein, when the HARQ-ACK feedback information and service data are transmitted on a same sub-frame, the method further comprises:
receiving, by the base station, the HARQ-ACK feedback information through the determined PUCCH or PUSCH resources bearing the service data.

21. The transmission method according to claim 20, wherein the step of receiving the HARQ-ACK feedback information through PUSCH resources bearing the service data comprises:
receiving the HARQ-ACK feedback information according to a way of transmitting service data through the PUSCH;
or selecting a PRB pair from resources corresponding to the PUSCH bearing the service data, and receiving the HARQ-ACK feedback information by means of a PUCCH format 1a/1b.

22. The transmission method according to claim 20, wherein the method further comprises:
receiving, by the base station, the service data according to a number of sub-frames after addition;
or after the service data are transmitted, receiving the service data according to a way of adaptively repetitively transmitting;
or according to a number of sub-frames for simultaneously transmitting the HARQ-ACK feedback information and the service data, determining whether to receive the service data according to the way of adaptively repetitively transmitting after the service data are transmitted.

23. A transmission method for Hybrid Automatic Repeat Request Acknowledgement (HARQ-ACK) feedback information, comprising: when a terminal is in a coverage-enhanced scenario,
determining, by the terminal, a Physical Uplink Control Channel (PUCCH) corresponding to the terminal according to a preset transmission policy, wherein the transmission policy is: receiving, by the terminal, PUCCH indication signaling from a base station, the indication signaling carrying information of one PUCCH of preset N PUCCHs, the one PUCCH being a PUCCH corresponding to the terminal, wherein N is a positive integer greater than or equal to 2; or determining a PUCCH corresponding to the terminal according to preset resources; or determining a preset terminal-specific PUCCH to be a PUCCH corresponding to the terminal; and
transmitting, by the terminal, HARQ-ACK feedback information through the determined PUCCH.

24. (canceled)

25. The transmission method according to claim 23, wherein, the transmission policy is: receiving, by the terminal, PUCCH indication signaling from the base station, when the indication signaling carries information of one PUCCH of preset N PUCCHs, the preset N PUCCHs being continuous or discontinuous,
and,
wherein, when the PUCCHs are discontinuous PUCCH format 1/1a/1b channels, a spacing between two adjacent PUCCHs of the preset N PUCCHs is determined according to at least one of the following parameters:
a number N of the preset PUCCHs, an implicit mapping offset N_{PUCCH}⁽¹⁾ and a number Q⁽¹⁾ of PUCCH format 1/1a/1b channels included in hybrid PUCCH resources indexed as N_{RB}⁽²⁾,
and,
wherein, when the PUCCHs are discontinuous PUCCH format 2/2a/2b channels, a spacing between two adjacent PUCCHs of the preset N PUCCHs is determined according to at least one of the following parameters:
a number N of the preset PUCCHs, a total number N_{PUCCH,max}⁽²⁾ of PUCCH format 2/2a/2b channels, and a number Q⁽²⁾ of PUCCH format 2/2a/2b channels included in hybrid PUCCH resources indexed as N_{RB}⁽²⁾.

26. The transmission method according to claim 25, wherein, when the PUCCH is the PUCCH format 1/1a/1b channel,
a first PUCCH of the preset N PUCCHs is a PUCCH format 1/1a/1b channel indexed as 0; or a PUCCH format 1/1a/1b channel indexed as N_{PUCCH}⁽¹⁾−1; or a PUCCH format 1/1a/1b channel indexed as Q⁽¹⁾, wherein Q⁽¹⁾ is a number of PUCCH format 1/1a/1b channels included in hybrid PUCCH resources indexed as N_{RB}⁽²⁾,
or,
wherein, when the PUCCH is the PUCCH format 2/2a/2b channel,
a first PUCCH of the preset N PUCCHs is a PUCCH format 2/2a/2b channel indexed as 0;
or a PUCCH format 2/2a/2b channel indexed as N_{PUCCH,max}⁽²⁾−1, wherein N_{PUCCH,max}⁽²⁾ is a total number of PUCCH format 2/2a/2b channels; or a PUCCH format 2/2a/2b channel indexed as N_{PUCCH,max}⁽²⁾−Q⁽²⁾−1, wherein Q⁽²⁾ is a number of PUCCH format 2/2a/2b channels included in hybrid PUCCH resources indexed as N_{RB}⁽²⁾).

27. (canceled)

28. (canceled)

29. (canceled)

30. The transmission method according to claim 25, wherein the indication signaling comprises:
Downlink Control Information (DCI) signaling born in a Physical Downlink Control Channel (PDCCH) or Radio Resource Control (RRC) signaling born in a Physical Downlink Shared Channel (PDSCH),
and,
wherein the RRC signaling comprises signaling born in Msg2 or Msg4 related to a random access process; and
the RRC signaling is semi-static configuration signaling,
and,
wherein the DCI signaling comprises DCI signaling for indicating a PUCCH for transmitting HARQ-ACK feedback information or DCI signaling for resource allocation of PDSCHs;
a DCI format is a proprietary DCI format of the coverage-enhanced terminal; and
the DCI signaling is dynamic configuration signaling.

31. (canceled)

32. (canceled)

33. (canceled)

34. The transmission method according to claim 23, wherein the transmission policy is: determining a PUCCH corresponding to the terminal according to preset resources; and
the preset resources comprise at least one of follows:
Control Channel Elements (CCEs) occupied by PDCCH, a number of CCEs occupied by PDCCH, sub-frames occupied by PDCCH, a number of sub-frames occupied by PDCCH, sub-frames occupied by PUCCH, a number of sub-frames occupied by PUCCH, sub-frames occupied by PDSCH, a number of sub-frames occupied by PDSCH, Physical Resource Blocks (PRBs) occupied by PDSCH, a number of PRBs occupied by PDSCH and an identification of the terminal,
and,
wherein the step of determining a PUCCH corresponding to the terminal according to preset resources comprises:
acquiring a reference PUCCH;
determining a PUCCH offset according to the acquired reference PUCCH and the preset resources; and
calculating a sum of an index of the reference PUCCH and the PUCCH offset, wherein the sum value is a PUCCH index.

35. (canceled)

36. The transmission method according to claim 35, wherein, when the PUCCH is the PUCCH format 1/1a/1b, the reference PUCCH comprises:
a PUCCH format 1/1a/1b channel indexed as 0;
or a PUCCH format 1/1a/1b channel indexed as N_{PUCCH}⁽¹⁾−1; or a PUCCH format 1/1a/1b channel indexed as Q⁽¹⁾,
or,
wherein, when the PUCCH is the PUCCH format 2/2a/2b, the reference PUCCH comprises:
a PUCCH format 2/2a/2b channel indexed as 0;
or a PUCCH format 2/2a/2b channel indexed as N_{PUCCH,max}⁽²⁾−1; or a PUCCH format 2/2a/2b channel indexed as N_{PUCCH,max}⁽²⁾−Q⁽²⁾−1.

37. (canceled)

38. The transmission method according to claim 35, wherein the step of determining a PUCCH offset according to the acquired reference PUCCH and the preset resources comprises:
determining a direction of the PUCCH offset according to the acquired reference PUCCH; and
determining a magnitude of the PUCCH offset according to the preset resources.

39. The transmission method according to claim 38, wherein the step of determining a direction of the PUCCH offset according to the acquired reference PUCCH comprises:
when the acquired reference PUCCH is a PUCCH format 1/1a/1b channel indexed as 0, or a PUCCH format 2/2a/2b channel indexed as 0 or a PUCCH format 1/1a/1b channel indexed as Q⁽¹⁾, determining the direction of the PUCCH offset to be positive; and
when the acquired reference PUCCH is a PUCCH format 1/1a/1b channel indexed as N_{PUCCH}⁽¹⁾−1, or a PUCCH format 2/2a/2b channel indexed as N_{PUCCH,max}⁽²⁾−1 or a PUCCH format 2/2a/2b channel indexed as N_{PUCCH,max}⁽²⁾−Q⁽²⁾−1, determining the direction of the PUCCH offset to be negative,
or,
wherein the step of determining a magnitude of the PUCCH offset according to the preset resources comprises:
determining the magnitude of the PUCCH offset according to an index of a first sub-frame occupied by the PDCCH; or according to an index of a first CCE occupied by the PDCCH and the number of the CCEs; or according to the number of the sub-frames occupied by the PDCCH; or according to the index of the first CCE occupied by the PDCCH, the index of the first sub-frame, the number of the CCEs and the number of the sub-frames; or according to the number of the sub-frames occupied by the PUCCH; or according to the number of the sub-frames occupied by the PDSCH; or according to the identification of the terminal.

40. (canceled)

41. The transmission method according to claim 23, wherein the transmission policy is determining a preset terminal-specific PUCCH to be a PUCCH corresponding to the terminal, comprising:
a PUCCH format 1/1a/1b channel indexed as 0;
or a PUCCH format 1/1a/1b channel indexed as N_{PUCCH}⁽¹⁾−1; or a PUCCH format 1/1a/1b channel indexed as Q(1); or a PUCCH format 2/2a/2b channel indexed as 0; or a PUCCH format 2/2a/2b channel indexed as N_{PUCCH,max}⁽²⁾−1; or a PUCCH format 2/2a/2b channel indexed as N_{PUCCH,max}⁽²⁾−Q⁽²⁾−1.

42. The transmission method according to claim 23, wherein, when the HARQ-ACK feedback information and service data are transmitted on a same sub-frame, the method further comprises:
canceling, by the terminal, the transmission of the service data, and transmitting the HARQ-ACK feedback information through the determined PUCCH or PUSCH resources bearing the service data.

43. The transmission method according to claim 42, wherein the step of transmitting the HARQ-ACK feedback information through PUSCH resources bearing the service data comprises:
transmitting the HARQ-ACK feedback information according to a way of transmitting service data through the PUSCH;
or selecting a PRB pair from resources corresponding to the PUSCH bearing the service data, and transmitting the HARQ-ACK feedback information by means of a PUCCH format 1a/1b.

44. The transmission method according to claim 42, wherein the method further comprises:
transmitting, by the terminal, the service data according to a number of sub-frames after addition;
or after the service data are transmitted, adaptively repetitively transmitting the service data;
or according to a number of sub-frames for simultaneously transmitting the HARQ-ACK feedback information and the service data, determining whether to adaptively repetitively transmit the service data after the service data are transmitted.

45. A transmission system for Hybrid Automatic Repeat Request Acknowledgement (HARQ-ACK) feedback information, wherein the transmission system at least comprises a base station and a terminal, wherein,
the base station is configured to, when determining that the terminal is in a coverage-enhanced scenario, determine a Physical Uplink Control Channel (PUCCH) corresponding to the terminal according to a preset transmission policy; and receive HARQ-ACK feedback information through the PUCCH corresponding to the terminal; and
the terminal is configured to determine a PUCCH corresponding to the terminal according to a preset transmission policy; and transmit HARQ-ACK feedback information through the determined PUCCH;
wherein the transmission policy is:
transmitting, by the base station, PUCCH indication signaling to the terminal, the indication signaling carrying information of one PUCCH of preset N PUCCHs, the one PUCCH being a PUCCH corresponding to the terminal, wherein N is a positive integer greater than or equal to 2;
or determine a PUCCH corresponding to the terminal according to preset resources;
or determine a preset terminal-specific PUCCH to be a PUCCH corresponding to the terminal.

46. The transmission system according to claim 45, wherein the base station at least comprises a determining module, a first processing module and a first receiving module, wherein,
the determining module is configured to, when determining that the terminal is in a coverage-enhanced scenario, notify the first processing module;
the first processing module is configured to determine the PUCCH corresponding to the terminal according to the preset transmission policy; and
the first receiving module is configured to receive the HARQ-ACK feedback information from the terminal through the PUCCH corresponding to the terminal; and
the terminal at least comprises a second processing module and a second transmitting module, wherein,
the second processing module is configured to determine the PUCCH corresponding to the terminal according to the preset transmission policy; and
the second transmitting module is configured to transmit the HARQ-ACK feedback information through the determined PUCCH,
and,
wherein,
the base station further comprises a first transmitting module configured to receive a notification from the first processing module and transmit PUCCH indication information to the terminal; and correspondingly,
the terminal further comprises a second receiving module configured to receive the indication signaling from the base station and output the indication signaling to the second processing module.

47. (canceled)

48. A base station, comprising a determining module, a first processing module and a first receiving module, wherein,
the determining module is configured to, when determining that a terminal is in a coverage-enhanced scenario, notify the first processing module;
the first processing module is configured to determine a PUCCH corresponding to the terminal according to a preset transmission policy; and
the first receiving module is configured to receive HARQ-ACK feedback information from the terminal through the PUCCH corresponding to the terminal.

49. The base station according to claim 48, wherein the base station further comprises a first transmitting module configured to receive a notification from the first processing module and transmit PUCCH indication information to the terminal.

50. A terminal, in a coverage-enhanced scenario, at least comprising a second processing module and a second transmitting module, wherein,
the second processing module is configured to determine a PUCCH corresponding to the terminal according to a preset transmission policy; and
the second transmitting module is configured to transmit HARQ-ACK feedback information through the determined PUCCH.

51. The terminal according to claim 50, wherein the terminal further comprises a second receiving module configured to receive indication signaling from a base station and output the indication signaling to the second processing module.

52. (canceled)

53. (canceled)

54. (canceled)

55. (canceled)
